(19) United States
(12) Patent Application Publication
(10) Pub. No.: US 2016/0209566 A1
(43) Pub. Date: Jul. 21, 2016

(54) DOUBLE-SIDED PRESSURE-SENSITIVE-ADHESIVE-LAYER-ATTACHED POLARIZING FILM, METHOD FOR PRODUCING THEREOF, AND IMAGE DISPLAY DEVICE

(71) Applicant: NITTO DENKO CORPORATION, Osaka (JP)

(72) Inventors: Atsushi YASUI, Osaka (JP); Shou TAKARADA, Osaka (JP); Masaki MIZUTANI, Osaka (JP); Hirofumi KATAMI, Osaka (JP); Shinya YAMAMOTO, Osaka (JP)

(73) Assignee: NITTO DENKO CORPORATION, Osaka (JP)

(21) Appl. No.: 15/000,322

(22) Filed: Jan. 19, 2016

(30) Foreign Application Priority Data
Jan. 20, 2015 (JP) 2015-008802
Nov. 30, 2015 (JP) 2015-233272

(51) Int. Cl. G02B 5/30; G02F 1/1335

(52) U.S. Cl. CPC G02B 5/3033; G02F 1/133528

(57) ABSTRACT

A double-sided pressure-sensitive-adhesive-layer-attached polarizing film which is good in yield ratio, and satisfies step-absorbing capability provided that the film is a double-sided pressure-sensitive-adhesive-layer-attached polarizing film having a pressure-sensitive adhesive layer on each of the two surfaces of a polarizing film which is provided nearest to a viewer-side of an image display device among at least one polarizing film used in the device, and having the structure and properties as described.

### TECHNICAL FIELD

The present invention relates to a double-sided pressure-sensitive-adhesive-layer-attached polarizing film in which a pressure-sensitive adhesive layer is provided on both surfaces of a polarizing film which is nearest to a viewer-side of an image display device among at least one polarizing film used in the device, and a method for producing thereof. The invention also relates to an image display device in which at a viewer-side thereof, the double-sided pressure-sensitive-adhesive-layer-attached polarizing film is arranged. Examples of the image display device include a liquid crystal display device, an organic EL (electroluminescence) display device, a PDP (plasma display panel), and electronic paper.

The double-sided pressure-sensitive-adhesive-layer-attached polarizing film of the present invention has a pressure-sensitive adhesive layer over each of the two surfaces of a polarizing film. The pressure-sensitive adhesive layer at a viewer-side of the polarizing film is favorably applicable to, for example, a member to be applied to a viewer-side of an image display device, examples of the member including touch panels and other inputting devices, and cover glasses, plastic covers and other transparent substrates. In the meantime, the pressure-sensitive adhesive layer at the side of the film that is opposite to the viewer-side thereof is applied to a display section of the image display device. The polarizing film of the invention is favorably usable for, e.g., optical type, ultrasonic type, static electricity capacitance type or resistance film type one out of the touch panels. The polarizing film is favorably usable, in particular, for a static electricity capacitance type touch panel. The touch panels are each used in, for example, a portable telephone, a tablet computer, or a portable information terminal although the device in which the touch panel is used is not particularly limited.

### BACKGROUND ART

About any liquid crystal display device or the like, it is indispensable, from the viewpoint of an image-forming manner thereof, that a polarizer is arranged on each of the two main sides of its liquid crystal cell. A polarizing film is generally bonded, as the polarizer, to each of the sides. In order to bond the polarizing film onto a display section side of the liquid crystal cell or the like, a pressure-sensitive adhesive is usually used. In such a case, the pressure-sensitive adhesive is provided in advance as a pressure-sensitive adhesive layer on one side of a polarizing film, and the resulting pressure-sensitive-adhesive-layer-attached polarizing film is generally used because it has some advantages such as no need for a drying process to fix the polarizing film. As the pressure-sensitive-adhesive-layer-attached polarizing film, various films are suggested (Patent Documents 1 and 2). About these pressure-sensitive-adhesive-layer-attached polarizing films, the pressure-sensitive-adhesive-layer side of the films is applied onto a display section of a liquid crystal cell, or the like.

In the meantime, an inputting device such as a touch panel, a transparent substrate such as a cover glass or plastic cover, or some other member is located at the viewer-side of the polarizing films. The member is also generally bonded through a pressure-sensitive adhesive layer to each of the polarizing films (Patent Document 3).

### PRIOR ART DOCUMENTS

### Patent Documents

Patent Document 1: JP-A-2004-170907

Patent Document 2: JP-A-2006-053531

Patent Document 3: JP-A-2002-348150

### SUMMARY OF THE INVENTION

### Problems to be Solved by the Invention

As described in Patent Documents 1 and 2, about a pressure-sensitive-adhesive-layer-attached polarizing film which is nearest to a viewer-side of an image display device among at least one polarizing film used in the device, the pressure-sensitive adhesive layer of this pressure-sensitive-adhesive-layer-attached polarizing film is bonded onto a display section of the device. In the meantime, when a transparent substrate or some other member is located onto the viewer-side of the pressure-sensitive-adhesive-layer-attached polarizing film (to be located nearest to a viewer-side of an image display device among at least one polarizing film used in the device), a pressure-sensitive sheet for an intermediate film is separately prepared as disclosed in Patent Document 3, and then this sheet is bonded, as a pressure-sensitive adhesive layer, onto the polarizing film of the pressure-sensitive-adhesive-layer-attached polarizing film. Furthermore, the transparent substrate or other member is bonded onto the pressure-sensitive adhesive layer. As described herein, when a transparent substrate, or some other member is further bonded onto a polarizing film nearest to a viewer-side of an image display device among at least one polarizing film used in the device, plural processing-steps are required.

As the pressure-sensitive-adhesive-layer-attached polarizing film, Patent Documents 1 and 2 each disclose a polarizing film having, on each of the two surfaces thereof, a pressure-sensitive adhesive layer (full lamination: double-sided pressure-sensitive-adhesive-layer-attached polarizing film). However, when the double-sided pressure-sensitive-adhesive-layer-attached polarizing film is bonded to adherends (i.e., a transparent substrate or some other member at a viewer-side of the film, and a display section of an image display device at a side of the film that is opposite to the viewer-side), the respective edges of bonded surfaces of the resultant easily bite an air bubble, or some other inconvenience is caused, thereby the film is inferior in workability. Thus, an image display device obtained using the film is insufficient in yield ratio. Thus, in connection with the double-sided pressure-sensitive-adhesive-layer-attached polarizing film, the following are required: an image-display-device-producing process as described above is simplified; the film is improved in workability, and the above-mentioned yield ratio is improved.

In each surface of the transparent substrate or other member, which is, for example, a cover glass, steps are generated by a printed ink present thereon. Thus, when the step-surface-having member is bonded onto another member through a pressure-sensitive adhesive layer, the pressure-sensitive adhesive layer is required to absorb the steps to follow the steps not to generate any gap between the two members. An index of the pressure-sensitive adhesive layer that is related to the steps is a step-absorbing capability (%): the value of [“step height (μm)”/“thickness (μm) of the pressure-sensitive adhesive layer”]×100. In order that the pressure-sensitive adhesive layer can have a satisfied step-following performance, this layer is required to have a step-absorbing capability of about 20%. In recent years, the layer is required to have a high-level step-absorbing capability of 30%. It is generally conceivable that in order that the pressure-sensitive adhesive layer can absorb the steps, this layer is lowered in elastic modulus to be made soft. However, when the pressure-sensitive adhesive layer is made soft, the layer is deteriorated in workability and a large quantity of adhesive residues is generated. Thus, this pressure-sensitive adhesive layer is unfavorable in handleability.

In the meantime, when the pressure-sensitive adhesive layer (at the transparent-substrate- or other-member-bonded side) of the double-sided pressure-sensitive-adhesive-layer-attached polarizing film is made hard, the adhesive layer is lowered in step-absorbing capability by full lamination so that foams are easily generated to deteriorate the reliability.

Thus, an object of the present invention is to provide a double-sided pressure-sensitive-adhesive-layer-attached polarizing film which has a pressure-sensitive adhesive layer on each of the two surfaces of a polarizing film which is provided nearest to a viewer-side of an image display device among at least one polarizing film used in the device, the double-sided pressure-sensitive-adhesive-layer-attached polarizing film being excellent in yield ratio, and satisfying an step-absorbing capability, and a method for producing the same.

Another object of the present invention is to provide an image display device having the double-sided pressure-sensitive-adhesive-layer-attached polarizing film.

### Means for Solving the Problems

In order to solve the problems, the inventors have made eager investigations to find out a double-sided pressure-sensitive-adhesive-layer-attached polarizing film described below. Thus, the present invention has been achieved.

The invention relates to a double-sided pressure-sensitive-adhesive-layer-attached polarizing film, comprising:

a polarizing film which is provided nearest to a viewer-side of an image display device among at least one polarizing film used in the device;

a pressure-sensitive adhesive layer A arranged at the viewer-side of the polarizing film;

a pressure-sensitive adhesive layer B arranged at aside of the polarizing film that is opposite to the pressure-sensitive adhesive layer A;

a separator SA₁ provided on the pressure-sensitive adhesive layer A; and

a separator SB provided on the pressure-sensitive adhesive layer B; and

wherein the pressure-sensitive adhesive layer A has a storage modulus of 0.02 to 0.3 MPa at 23° C., and

about a rectangular piece cut out from the double-sided pressure-sensitive-adhesive-layer-attached polarizing film, the piece having a length of 300 mm in the direction of an absorption axis of the polarizing film, and a length of 250 mm in a direction orthogonal to the absorption axis, in an analysis of putting the piece on a horizontal plane such that a surface of the piece that is curled into a convex form faces downward, and then measuring the quantity of the curl (provided that the curl quantity measured in the state that the double-sided pressure-sensitive-adhesive-layer-attached polarizing film is put onto the horizontal plane such that the separator SB side of the film faces downward is represented by a numerical value with “+”, and the curl quantity measured in the state that the double-sided pressure-sensitive-adhesive-layer-attached polarizing film is put onto the horizontal plane such that the separator SA₁ side of the film faces downward is represented by a numerical value with “−”), the curl quantity is from −10 to +60 mm.

In the double-sided pressure-sensitive-adhesive-layer-attached polarizing film of the invention, the curl quantity is preferably from +2 to +30 mm.

In the double-sided pressure-sensitive-adhesive-layer-attached polarizing film of the invention, the separator SA₁ preferably has a thickness of 50 μm or more, and the separator SB preferably has a thickness of 30 to 55 μm.

In the double-sided pressure-sensitive-adhesive-layer-attached polarizing film of the invention, a peel strength a₁ of the separator SA₁ is preferably higher than a peel strength b of the separator SB.

The invention also relates to a method for producing a double-sided pressure-sensitive-adhesive-layer-attached polarizing film of the invention,

comprising a step (1) of:

preparing a single-sided pressure-sensitive-adhesive-layer-B-attached polarizing film having a polarizing film which is provided nearest to a viewer-side of an image display device among at least one polarizing film used in the device, a pressure-sensitive adhesive layer B, and a separator SB provided onto the pressure-sensitive adhesive layer B;

preparing a single-sided separator-attached pressure-sensitive adhesive layer A having a separator SA₁, and a pressure-sensitive adhesive layer A arranged over the separator SA₁ and having a storage modulus of 0.02 to 0.3 MPa at 23° C.; and

bonding the single-sided pressure-sensitive-adhesive-layer-B-attached polarizing film and the single-sided separator-attached pressure-sensitive adhesive layer A to each other, in a roll-to-roll manner, to arrange the pressure-sensitive adhesive layer A of the single-sided separator-attached pressure-sensitive adhesive layer A over a side of the polarizing film of the single-sided pressure-sensitive-adhesive-layer-B-attached polarizing film, the side being an side of the polarizing film that is opposite to the pressure-sensitive adhesive layer B arranged side of the polarizing film.

In the method for producing the double-sided pressure-sensitive-adhesive-layer-attached polarizing film of the invention, the single-sided separator-attached pressure-sensitive adhesive layer A is a layer obtained through a step (a) of peeling off, from a double-sided separator-attached pressure-sensitive adhesive layer A having the separator SA₁ at one side of the pressure-sensitive adhesive layer A and having a separator SA₂ at the other side of the pressure-sensitive adhesive layer A, the separator SA₂; and

a peel strength a₁ of the separator SA₁, a peel strength a₂ of the separator SA₂, and a peel strength b of the separator SB preferably satisfy a relationship of a₁>a₂ b.

In the method for producing the double-sided pressure-sensitive-adhesive-layer-attached polarizing film of the invention, the peel strength a₁ of the separator SA₁, the peel strength a₂ of the separator SA₂, and the peel strength b of the separator SB preferably satisfy a relationship of a₁>1.5a₂≦1.5b.

In the method for producing the double-sided pressure-sensitive-adhesive-layer-attached polarizing film of the invention, in the roll-to-roll manner bonding step (1), the ratio of the tensile strength T1 of the single-sided separator-attached pressure-sensitive adhesive layer A to the tensile strength T2 of the single-sided pressure-sensitive-adhesive-layer-B-attached polarizing film (T1/T2) is preferably controlled into 0.8 or more.

The method for producing the double-sided pressure-sensitive-adhesive-layer-attached polarizing film of the invention, preferably comprises, after the step (1),

a step (b) of peeling off the separator SA₁ from the resultant double-sided pressure-sensitive-adhesive-layer-attached polarizing film, and

a step (2) of bonding a separator SA₁′ for curl-adjustment in a roll-to-roll manner to the pressure-sensitive adhesive layer A of the double-sided pressure-sensitive-adhesive-layer-attached polarizing film, from which the separator SA₁ has been peeled off.

In the method for producing the double-sided pressure-sensitive-adhesive-layer-attached polarizing film of the invention, in the roll-to-roll-manner bonding step (2),

the ratio of the tensile strength T3 of the separator SA₁′ for curl-adjustment to the tensile strength T4 of the double-sided pressure-sensitive-adhesive-layer-attached polarizing film, from which the separator SA₁ has been peeled off, (T3/T4) is preferably controlled to 0.8 or more.

The method for producing the double-sided pressure-sensitive-adhesive-layer-attached polarizing film of the invention, preferably comprises, after the step (1),

a step (c) of cutting the resultant double-sided pressure-sensitive-adhesive-layer-attached polarizing film into any size, and

a step (d) of cutting an edge of the double-sided pressure-sensitive-adhesive-layer-attached polarizing film obtained by the cutting.

The invention also relates to an image display device, having at least one or more double-sided pressure-sensitive-adhesive-layer-attached polarizing films,

wherein the double-sided pressure-sensitive-adhesive-layer-attached polarizing film which is provided nearest to a viewer-side of an image display device among at least one polarizing film used in the device, is a double-sided pressure-sensitive-adhesive-layer-attached polarizing film obtained by removing the separators SA₁ and SB from the double-sided pressure-sensitive-adhesive-layer-attached polarizing film recited in any one of claims 1 to 4, and

the pressure-sensitive adhesive layer A of the double-sided pressure-sensitive-adhesive-layer-attached polarizing film is arranged at the viewer-side of the image display device, and the pressure-sensitive adhesive layer B of the double-sided pressure-sensitive-adhesive-layer-attached polarizing film is arranged at a display section side of the device.

### Effect of the Invention

In image display devices, at a position at a viewer-side of the devices and outside the polarizing film which is nearest to a viewer-side of an image display device among at least one polarizing film used in the device, a cover glass or any other transparent substrate, or some other member may be arranged. Conventionally, at the viewer-side, a pressure-sensitive adhesive layer and the substrate or other member are successively laminated onto the polarizing film. However, the pressure-sensitive-adhesive-layer-attached polarizing film of the present invention is a double-sided pressure-sensitive-adhesive-layer-attached polarizing film in which a pressure-sensitive adhesive layer to be bonded onto a transparent substrate or some other member is located on one surface of a polarizing film while another pressure-sensitive adhesive layer to be bonded to a display section of an image display device is located on the film surface opposite thereto. The polarizing film has, at a viewer-side thereof also, one of the pressure-sensitive adhesive layers; thus, production-steps of the image display device can be simplified. Moreover, according to the polarizing film, in which the pressure-sensitive adhesive layer is beforehand laid on each of the two surface, by the working of this film into pieces each having a predetermined size, the resultants or the image display device can be improved in productivity and quality.

In the double-sided pressure-sensitive-adhesive-layer-attached polarizing film of the present invention, the pressure-sensitive adhesive layers A and B of both the surfaces thereof have the separator SA₁ and the separator SB, respectively; and the separators SA₁ and SB control the curl quantity of the film into the predetermined quantity range. When the double-sided pressure-sensitive-adhesive-layer-attached polarizing film is bonded to a display section of an image display device and when the film is bonded to a transparent substrate or some other member, the control of the curl quantity in the way described just above makes it possible to restrain the respective edges of bonded surfaces of the resultant from biting any air bubble. Thus, the double-sided pressure-sensitive-adhesive-layer-attached polarizing film improves working efficiency, and the above-mentioned yield ratio can be improved.

In the double-sided pressure-sensitive-adhesive-layer-attached polarizing film of the present invention, the storage modulus of the pressure-sensitive adhesive layer A (i.e., the pressure-sensitive adhesive layer to which a transparent substrate such as a cover glass, or some other member is to be bonded) arranged at the viewer-side of the polarizing film is controlled into the predetermined range. Thus, the double-sided pressure-sensitive-adhesive-layer-attached polarizing film is good in handle ability without causing adhesive residues or other problems. Moreover, the pressure-sensitive adhesive layer, the storage modulus of which is controlled into the predetermined range, makes it possible to restrain the step-absorbing capability from being lowered by full-lamination. Furthermore, the pressure-sensitive adhesive layer makes it possible to restrain the durability of the double-sided pressure-sensitive-adhesive-layer-attached polarizing film, which is related to the reliability thereof, from being lowered (or restrain the generation of the air bubble).

When the pressure-sensitive adhesive layer A is formed to be a multiple pressure-sensitive adhesive layer having at least two pressure-sensitive adhesive layers, the following advantage can be produced: even when the transparent substrate or other member is a member having a surface having steps, the multiple pressure-sensitive adhesive layer can follow the steps to attain the bonding without generating any gap.

The double-sided pressure-sensitive-adhesive-layer-attached polarizing film of the present invention can be produced through, for example, the step of bonding a single-sided separator-attached pressure-sensitive adhesive layer A having a pressure-sensitive adhesive layer A to a single-sided pressure-sensitive-adhesive-layer-B-attached polarizing film having a separator SB in a roll-to-roll-manner. The roll-to-roll-manner bonding step makes it possible to improve the workpiece in handleability to restrain adhesive residues, and further improve the resultant double-sided pressure-sensitive-adhesive-layer-attached polarizing film in workability.

When the respective tensile strengths of the single-sided separator-attached pressure-sensitive adhesive layer A and the single-sided pressure-sensitive-adhesive-layer-B-attached polarizing film are controlled in the roll-to-roll-manner bonding step, the curl quantity of the resultant double-sided pressure-sensitive-adhesive-layer-attached polarizing film can be controlled into the predetermined range. Also, by bonding the separator SA₁′ for curl-adjustment instead of the separator SA₁ in the double-sided pressure-sensitive-adhesive-layer-attached polarizing film, the curl quantity of the film can be controlled into the predetermined range.

### BRIEF DESCRIPTION OF THE DRAWINGS

FIG. 1A is a sectional view that schematically illustrates an embodiment of a double-sided pressure-sensitive-adhesive-layer-attached polarizing film of the present invention;

FIG. 1B is a sectional view that schematically illustrates an embodiment of the double-sided pressure-sensitive-adhesive-layer-attached polarizing film of the present invention;

FIG. 2A is a sectional view that schematically illustrates the curl quantity of a double-sided pressure-sensitive-adhesive-layer-attached polarizing film of the invention;

FIG. 2B is a sectional view that schematically illustrates the curl quantity of the double-sided pressure-sensitive-adhesive-layer-attached polarizing film of the invention;

FIG. 3 is a schematic view illustrating a state that an image display device and a transparent substrate or some other member are bonded to each other through a double-sided pressure-sensitive-adhesive-layer-attached polarizing film of the invention;

FIG. 4A is a sectional view that schematically illustrates an embodiment of an image display device of the invention;

FIG. 4B is a sectional view that schematically illustrates an embodiment of the image display device of the invention;

FIG. 4C is a sectional view that schematically illustrates an embodiment of the image display device of the invention;

FIG. 5 is a sectional view that schematically illustrates a form of a double-sided separator-attached pressure-sensitive adhesive layer A;

FIG. 6 is a sectional view that schematically illustrates a form of a roll-to-roll-manner bonding step (1) in a method for producing a double-sided pressure-sensitive-adhesive-layer-attached polarizing film of the invention; and

FIG. 7 is a sectional view that schematically illustrates a form of a roll-to-roll-manner bonding step (2) using a separator for curl-adjustment in a method for producing a double-sided pressure-sensitive-adhesive-layer-attached polarizing film of the invention.

### DETAILED DESCRIPTION OF THE PREFERRED EMBODIMENTS

Hereinafter, with reference to the drawings, embodiments of the double-sided pressure-sensitive-adhesive-layer-attached polarizing film of the present invention will be detailed in detail. However, the invention is not limited to the embodiments in the drawings.

As illustrated in each of FIGS. 1A and 1B, a double-sided pressure-sensitive-adhesive-layer-attached polarizing film 10 (10′) of an embodiment of the present invention has a polarizing film 1, and a pressure-sensitive adhesive layer A and a pressure-sensitive adhesive layer B on the two surfaces of the polarizing film 1, respectively. In the double-sided pressure-sensitive-adhesive-layer-attached polarizing film 10 (10′) of the invention, the pressure-sensitive adhesive layer A has a separator SA₁, and the pressure-sensitive adhesive layer B has a separator SB. The separator SA₁ may be a separator SA₁′ for curl-adjustment that will be detailed later.

FIG. 1A illustrates a case where the pressure-sensitive adhesive layer A is made of a single layer. The pressure-sensitive adhesive layer A may be rendered a multiple pressure-sensitive adhesive layer having a first pressure-sensitive adhesive layer (a) and a second pressure-sensitive adhesive layer (b) in this order from an outermost surface side (viewer-side) of the film 10. FIG. 1B illustrates a case where the pressure-sensitive adhesive layer A is a multiple layer composed of a first pressure-sensitive adhesive layer (a) and a second pressure-sensitive adhesive layer (b). The number of layers in the multiple pressure-sensitive adhesive layer, which is the pressure-sensitive adhesive layer A, is not particularly limited. Usually, the number is about 5 or less. The number of the layers of the multiple pressure-sensitive adhesive layer is preferably from 2 to 4, more preferably from 2 to 3. In the multiple pressure-sensitive adhesive layer, the individual layers are laid to be caused to adhere directly and closely to each other.

Any adjacent two out of the layers of the multiple pressure-sensitive adhesive layer are pressure-sensitive adhesive layers different from each other in composition. However, any two not adjacent to each other, out of the layers, may be pressure-sensitive adhesive layers having the same composition. In FIG. 1B, the first and second pressure-sensitive adhesive layers (a) and (b) have different compositions. In the case of using, as a pressure-sensitive adhesive layer A of a double-sided pressure-sensitive-adhesive-layer-attached polarizing film, a first pressure-sensitive adhesive layer (a), a second pressure-sensitive adhesive layer (b) and a third pressure-sensitive adhesive layer (c) from an outermost surface side (viewer-side) of the film, the first and second pressure-sensitive adhesive layers (a) and (b) are different from each other in composition, and the second and third pressure-sensitive adhesive layers (b) and (c) are different from each other in composition. The first, second and third pressure-sensitive adhesive layers (a), (b) and (c) may be different from each other in composition; however, the first and third pressure-sensitive adhesive layers (a) and (c) may have the same composition.

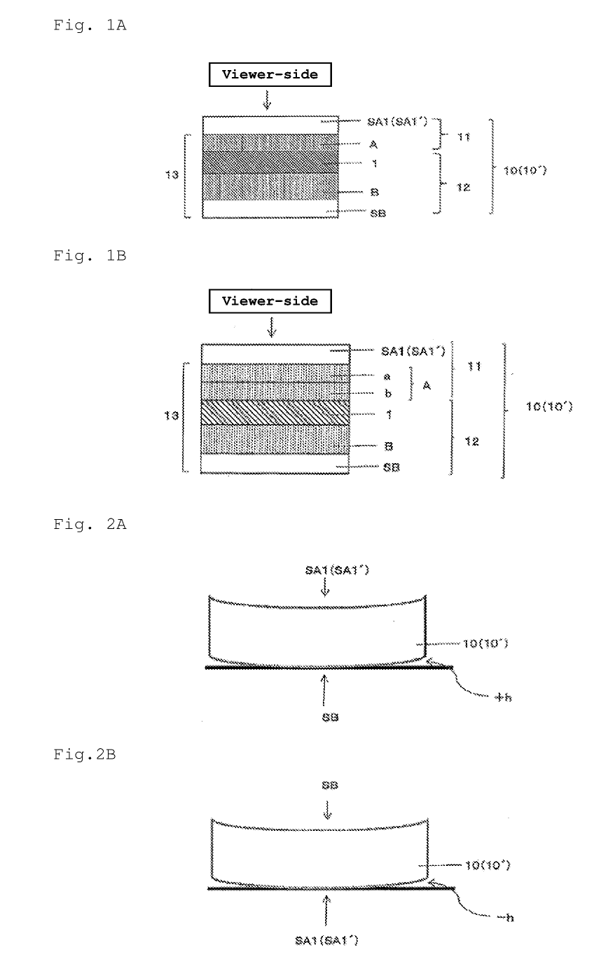

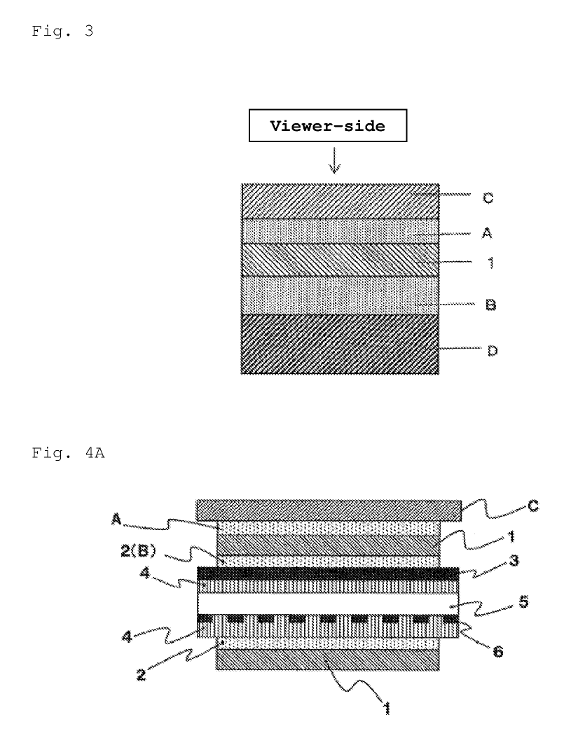

FIGS. 2A and 2B are each a sectional view that schematically illustrates the curl quantity of the double-sided pressure-sensitive-adhesive-layer-attached polarizing film 10 (or 10′) of the present invention. The curl quantity is measured about a rectangular piece cut out from the double-sided pressure-sensitive-adhesive-layer-attached polarizing film 10 (or 10′), this piece having a length of 300 mm in the direction of an absorption axis of the polarizing film, and a length of 250 mm in a direction orthogonal to the absorption axis. As illustrated in each of FIGS. 2A and 2B, the measurement of the curl quantity is made in the state that the piece is put onto a horizontal plane such that a surface of the piece that is curled into a convex form faces downward. Furthermore, as illustrated in FIG. 2A, in the analysis of the curl quantity, the curl quantity “h” measured in the state that the double-sided pressure-sensitive-adhesive-layer-attached polarizing film 10 (or 10′) is put onto the horizontal plane such that the separator SB side of the film 10 (or 10′) faces downward is represented by a numerical value with “+”. As illustrated in FIG. 2B, the curl quantity “h” measured in the state that the film 10 is put onto the horizontal plane such that the separator SA₁ (or SA₁′) side of the film 10 (or 10′) faces downward is represented by a numerical value with “−”. The curl quantity “h” corresponds to the distance (mm) of a point farthest from the horizontal plane, out of four corner points of the rectangular piece, from the plane.

The curl quantity “h” is controlled into the range of −10 to +60 mm from the viewpoint of the above-mentioned working efficiency and yield ratio. From the same viewpoint, the curl quantity “h” is preferably a value with “+” as illustrated in FIG. 2A, and is more preferably from +2 to +30 mm, even more preferably from +5 to +20 mm.

### <Pressure-Sensitive Adhesive Layers>

Hereinafter, a description will be made about the pressure-sensitive adhesive layers A and B in the present invention. The pressure-sensitive adhesive layers A and B are each “transparent”, and can satisfy the transparency when the layers each have a haze value of 2% or less, the value being measured when the thickness thereof is 25 μm. The haze value is preferably from 0 to 1.5%, more preferably from 0 to 1%.

### <Thickness of Pressure-Sensitive Adhesive Layer>

The total thickness of the pressure-sensitive adhesive layer A is preferably from 5 μm to 1 mm. The total thickness of the pressure-sensitive adhesive layer A can be appropriately set in accordance with a site to which the pressure-sensitive adhesive layer A is applied. The total thickness of the pressure-sensitive adhesive layer A is more preferably from 10 μm to 500 μm, even more preferably from 20 μm to 300 μm.

When the pressure-sensitive adhesive layer A is a multiple pressure-sensitive adhesive layer having a first pressure-sensitive adhesive layer (a) and a second pressure-sensitive adhesive layer (b), the thickness of each of pressure-sensitive adhesive layers (a) and (b), is preferably from 3 to 200 μm, more preferably from 5 to 150 μm, even more preferably from 10 to 100 μm.

When the pressure-sensitive adhesive layer A has a bilayered structure of the first and second pressure-sensitive adhesive layers (a) and (b) as has been illustrated in FIG. 1B, the thickness of the first pressure-sensitive adhesive layer (a) is preferably from 3 to 200 μm, more preferably from 5 to 100 μm, even more preferably from 10 to 75 μm. The thickness of the second pressure-sensitive adhesive layer (b) is preferably from 10 to 300 μm, more preferably from 20 to 150 μm, even more preferably from 50 to 100 μm. The difference in thickness between the first and second pressure-sensitive adhesive layers (a) and (b) is preferably from 20 to 270 μm, more preferably from 30 to 200 μm from the viewpoint of the step-absorbing capability and workability of the layers.

In the meantime, the thickness of the pressure-sensitive adhesive layer B is generally from 1 to 500 μm, preferably from 5 to 200 μm, in particular preferably from 10 to 100 μm.

### <Storage Modulus of Pressure-Sensitive Adhesive Layer A>

The storage modulus of the pressure-sensitive adhesive layer A is controlled in the range of 0.02 to 0.3 MPa at 23° C. The pressure-sensitive adhesive layer A, the storage modulus of which is controlled in this range, makes it possible to restrain adhesive residues and improve the working efficiency of bonding the double-sided pressure-sensitive-adhesive-layer-attached polarizing film to a transparent substrate to improve the yield ratio of the image display device. The storage modulus is preferably from 0.02 to 0.4 MPa, more preferably from 0.03 to 0.3 MPa, even more preferably from 0.05 to 0.1 MPa. The control of the storage modulus of the pressure-sensitive adhesive layer A is favorable also for the step-absorbing capability.

### <Peel Strength of Each Separator>

The pressure-sensitive adhesive layers A and B have the separator SA₁ (or SA′) and the separator SB, respectively. The peel strength a₁ of the separator SA₁ (or SA₁′) from the pressure-sensitive adhesive layer A is preferably from 0.01 to 5 N/50 mm, more preferably from 0.05 to 2 N/50 mm, even more preferably from 0.1 to 1 N/50 mm. The peel strength b of the separator SB from the pressure-sensitive adhesive layer B is preferably from 0.01 to 5 N/50 mm, more preferably from 0.05 to 2 N/50 mm, even more preferably from 0.1 to 1 N/50 mm.

It is preferred to make an adjustment to make the peel strength a₁ of the separator SA₁ (or SA′) higher than that b of the separator SB to bond the pressure-sensitive adhesive layer A ahead to a display panel. The difference between the peel strength a1 of the separator SA₁ (or SA′) and that b of the separator SB is preferably from 0.01 to 2 N/50 mm, more preferably from 0.02 to 1 N/50 mm to prevent a failure of the peel.

The storage modulus, and the peel strengths are each measured on the basis of a description in the item “Examples”.

As illustrated in FIG. 3, about the double-sided pressure-sensitive-adhesive-layer-attached polarizing film of the present invention, members obtained by removing, from the film, the separator SA₁ (or SA′) and the separator SB are applied to an image display device. The polarizing film of the present double-sided pressure-sensitive-adhesive-layer-attached polarizing film is used as a polarizing film which is nearest to a viewer-side of an image display device among at least one polarizing film used in the device. The pressure-sensitive adhesive layer A of the present double-sided pressure-sensitive-adhesive-layer-attached polarizing film is arranged at the viewer-side of the image display device, and is bonded to a member C, such as a transparent substrate. The pressure-sensitive adhesive layer B is arranged at the side of the polarizing film 1 that is opposite to the pressure-sensitive adhesive layer A side, and is bonded to a display section D of the device.

The member C may be a member used at the viewer-side of the image display device, such as a touch panel or any other inputting device, or a cover glass, a plastic cover or any other transparent substrate.

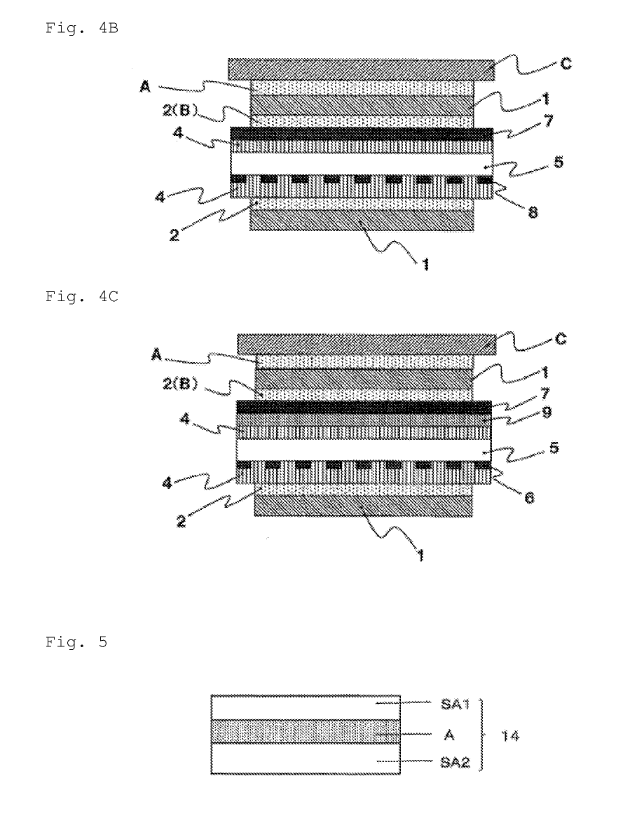

The display section D is a section combined with the polarizing film 1 and the same polarizing film (s) to forma section of the image display device, and may be, for example, a liquid crystal display device, an organic EL (electroluminescence) display device, a PDP (plasma display panel), or electric paper. The display section D is used together with the polarizing film 1. A liquid crystal display device having a liquid crystal layer 5 is favorably usable. FIGS. 4A to 4C each illustrate, as a schematic sectional view, a typical embodiment of an image display device (liquid crystal display device) to which the pressure-sensitive-adhesive-layer-attached polarizing film of the present invention is applied. In the image display device (liquid crystal display device) in each of FIGS. 4A to 4C, the polarizing film 1 at its upper region is nearest to a viewer-side of an image display device among at least one polarizing film used in the device.

The image display device (liquid crystal display device) illustrated in FIG. 4A has a structure of “cover glass C/pressure-sensitive adhesive layer A/polarizing film 1 (at the viewer-side)/pressure-sensitive adhesive layer 2 (B)/antistatic layer 3/glass substrate 4/liquid crystal layer 5/driving electrode 6/glass substrate 4/pressure-sensitive adhesive layer 2/polarizing film 1”. The antistatic layer 3 and the driving electrode 6 may be made of a transparent conductive layer. The antistatic layer 3 is optionally formed.

The image display device (liquid crystal display device) illustrated in FIG. 4B is a device in which a transparent conductive layer is used as an electrode of a touch panel (in-cell touch panel). The device has a structure of “cover glass C/pressure-sensitive adhesive layer A/polarizing film 1 (at the viewer-side)/pressure-sensitive adhesive layer 2 (B)/antistatic layer 7 functioning also as a sensor layer/glass substrate 4/liquid crystal layer 5/driving electrode 8 functioning also as a sensor layer/glass substrate 4/pressure-sensitive adhesive layer 2/polarizing film 1”. The antistatic layer 7 and the driving electrode 8 may each be made of a transparent conductive layer.

The image display device (liquid crystal display device) illustrated in FIG. 4C is a device in which a transparent conductive layer is used as an electrode of a touch panel (on-cell touch panel). The device has a structure of “cover glass C/pressure-sensitive adhesive layer A/polarizing film 1/pressure-sensitive adhesive layer 2 (B)/antistatic layer 7 functioning also as a sensor layer/sensor layer 9/glass substrate 4/liquid crystal layer 5/driving electrode 6/glass substrate 4/pressure-sensitive adhesive layer 2/polarizing film 1”. The antistatic layer 7, the sensor layer 9 and the driving electrode 6 may each be made of a transparent conductive layer.

A polarizing film including a polarizer and a transparent protective film provided on one or both sides of the polarizer is generally used. A functional layer such as a hard coat layer may be laid onto the transparent protective film in the polarizing film. Additionally, in the image display device, an optical film is appropriately used which is usable to form a liquid crystal display device, an organic EL display device or some other conventional image display device. The optical film may be used as other optical layers, such as a reflective plate, a transflective plate, a retardation plate (a half wavelength plate and a quarter wavelength plate included), an optical compensation film, a viewing angle compensation film and a brightness enhancement film, which may be used for formation of a liquid crystal display device etc. These films may be singly used as the optical film, or one or more thereof may be used in the state of being laminated onto the polarizing film when practically used.

In each of FIGS. 4A to 4C, the pressure-sensitive adhesive layer 2 is illustrated, which is to be bonded to the liquid crystal cell (glass substrate), or some other member. The pressure-sensitive adhesive layer 2 at the viewer-side (upper side) of the device when viewed from the liquid crystal cell is used as the pressure-sensitive adhesive layer B. For the pressure-sensitive adhesive layer 2, a pressure-sensitive adhesive that may be of various types is appropriately selected to be used, this adhesive containing, as a base polymer, for example, an acryl-based polymer, silicone polymer, polyester, polyurethane, polyamide, polyether, fluoropolymer, or rubber-based polymer. Particularly preferred is an acryl-based pressure-sensitive adhesive or any other pressure-sensitive adhesive having an excellent optical transparency and an appropriate wettability and showing pressure-sensitive adhesive properties of cohesiveness and adhesion to give weather resistance, heat resistance and other properties.

The liquid crystal display device is generally formed, for example, by fabricating appropriately a liquid crystal cell (having a structure of “glass substrate/liquid crystal layer/glass substrate”), polarizing films arranged at both sides thereof, respectively, and optional constituents such as a lighting system, and then incorporating a driving circuit to the fabricated body. The liquid crystal cell may be of any type, such as a TN type, STN type, π type, VA type, or IPS type. Moreover, this liquid crystal display device may be rendered an appropriate display device having a lighting system in which a backlight or reflector is used. When the liquid crystal display device is formed, one or more appropriate members may be arranged in the form of one or more layers at one or more appropriate positions of the device. Examples of the member(s) include a diffusion plate, an antiglare layer, an anti-reflection layer, a protective plate, a prism array, a lens array sheet, a light diffusion plate, and a backlight.

The member C may be a touch panel. The touch panel is a static electricity capacitance type touch panel, in which a transparent substrate, a pressure-sensitive adhesive layer 2, and a transparent conductive film are laminated in this order. Two or more transparent conductive films may be laminated. The transparent substrate may have a sensor layer. The transparent substrate may be singly applied, as a cover glass, a plastic cover or some other, to the image display device (liquid crystal display device). A hard coat film may be laid onto the transparent conductive film at the side of the device that is opposite to the transparent substrate side of the touch panel C.

The transparent substrate may be a glass plate or a transparent acrylic plate (PMMA plate). The transparent substrate is the so-called cover glass, and is usable as a decorative panel. The transparent conductive film is preferably a film in which a transparent conductive film is laid on a glass plate or transparent plastic film (in particular, a PET film). The transparent conductive film may be a thin film made of a metal, a metal oxide, or a mixture of the two, and is, for example, a thin film of ITO (indium tin oxide), ZnO, SnO, or CTO (cadmium tin oxide). The thickness of the transparent conductive film is not particularly limited, and may be from about 10 to 200 nm. A typical example of the transparent conductive film is an ITO film in which an ITO membrane is laid on a PET film. The transparent conductive film may be laid through an undercoat layer onto any member. Plural undercoat layers may be laid. An oligomer-shift preventing layer may be laid between the transparent plastic film substrate and the pressure-sensitive adhesive layer. The hard coat film is preferably a film in which a transparent plastic film such as a PET film is subjected to hard coat treatment.

The double-sided pressure-sensitive-adhesive-layer-attached polarizing film 10 of the present invention can be produced, for example, by preparing a single-sided pressure-sensitive-adhesive-layer-B-attached polarizing film 12 having a polarizing film 1 and a pressure-sensitive adhesive layer B having a separator SB, preparing a single-sided separator-attached pressure-sensitive adhesive layer A (11) having a pressure-sensitive adhesive layer A on a separator SA₁, and then bonding the single-sided pressure-sensitive-adhesive-layer-B-attached polarizing film and the single-sided separator-attached pressure-sensitive adhesive layer A to each other, in a roll-to-roll manner, to arrange the pressure-sensitive adhesive layer A of the single-sided separator-attached pressure-sensitive adhesive layer A (11) over one side of the polarizing film 1 of the single-sided pressure-sensitive-adhesive-layer-B-attached polarizing film 12, the side being an side of the film that is opposite to the pressure-sensitive adhesive layer B arranged side of the film. As illustrated in FIG. 6, this producing method is preferably performed through a roll-to-roll-manner bonding step (1). In FIG. 6, the single-sided pressure-sensitive-adhesive-layer-B-attached polarizing film 12 and the single-sided separator-attached pressure-sensitive adhesive layer A (11) fed out from respective feeding-out rolls are caused to perform the bonding step (1) between paired rolls R1 and R2 to yield, through a winding roll, the double-sided pressure-sensitive-adhesive-layer-attached polarizing film 10.

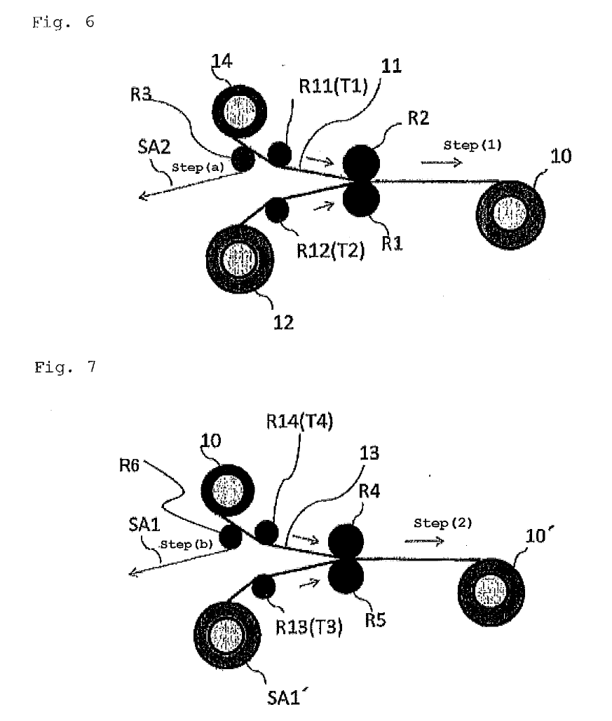

The single-sided separator-attached pressure-sensitive adhesive layer A (11) can be yielded from a double-sided separator-attached pressure-sensitive adhesive layer A (14) in which a pressure-sensitive adhesive layer has, at one of the two sides thereof, a separator SA₁ and has, at the other side, a separator SA₂. As illustrated in FIG. 5, the structure of the double-sided separator-attached pressure-sensitive adhesive layer A (14) can be represented as a structure of “separator SA₁/pressure-sensitive adhesive layer A/separator SA₂”. In FIG. 6, the double-sided separator-attached pressure-sensitive adhesive layer A (14) fed from a feeding-out roll is caused to perform a step (a) of peeling off the separator SA₂ through a peeling roll R3, and then the resultant single-sided separator-attached pressure-sensitive adhesive layer A (11) is supplied into the bonding step (1).

When the double-sided separator-attached pressure-sensitive adhesive layer A (14) is used, the peel strength a₁ of the separator SA₁, that a₂ of the separator SA₂ and that b of the separator SB preferably satisfy a relationship of a₁>a₂ b from the viewpoint of the order of steps for the resultant product, and the order of steps of the bonding to a liquid crystal panel, an organic EL panel or some other. Furthermore, the peel strength a₁ of the separator SA₁, that a₂ of the separator SA₂, and that b of the separator SB preferably satisfy a relationship of a₁>1.5a₂≦1.5b from the viewpoint of an improvement in working efficiency.

The peel strength a₁ of the separator SA₁, and that b of the separator SB are as described above. The peel strength a₂ of the separator SA₂ is preferably from 0.01 to 5 N/50-mm, more preferably from 0.05 to 2 N/50-mm, even more preferably from 0.05 to 1 N/50-mm. The difference between the peel strength a₁ of the separator SA₁ and that a₂ of the separator SA₂ is preferably from 0.01 to 1 N/50-mm, more preferably from 0.03 to 0.5 N/50-mm from the viewpoint of working efficiency of the step of the bonding to a polarizing plate.

About the double-sided pressure-sensitive-adhesive-layer-attached polarizing film 10 of the present invention, it is preferred in the roll-to-roll-manner bonding step (1) that the ratio of the tensile strength T1 of the separator-attached pressure-sensitive adhesive layer A (11) to that T2 of the single-sided pressure-sensitive-adhesive-layer-B-attached polarizing film (T1/T2) is controlled into 0.8 or more. In FIG. 6, the tensile strengths T1 and T2 are controllable through rolls R11 and R12, respectively.

The control of the tensile strength ratio (T1/T2) into the above-mentioned range makes it possible to adjust the curl quantity. The tensile strength ratio (T1/T2) is preferably 0.9 or more, more preferably 1 or more, even more preferably 3 or more. In the meantime, if the tensile strength ratio (T1/T2) becomes too large, the curl quantity becomes too large, thereby in the step of the bonding to a panel, the precision of the bonding is lowered. Thus, the tensile strength ratio (T1/T2) is preferably 10 or less, more preferably 6 or less, even more preferably 4 or less.

The tensile strength T1 is preferably from 8 to 500 N/m, more preferably from 50 to 300 N/m, even more preferably from 100 to 200 N/m.

The tensile strength T2 is preferably from 10 to 400 N/m, more preferably from 20 to 200 N/m, even more preferably from 40 to 100 N/m.

In the present invention, after the production of the double-sided pressure-sensitive-adhesive-layer-attached polarizing film 10, the separator SA₁ is peeled off from the pressure-sensitive adhesive layer A of the resultant double-sided pressure-sensitive-adhesive-layer-attached polarizing film 10; and subsequently a separator SA₁′ for curl-adjustment is bonded to the pressure-sensitive adhesive layer A of the resultant separator-SA₁-peeled double-sided pressure-sensitive-adhesive-layer-attached polarizing film, which is a film 13. In this way, a double-sided pressure-sensitive-adhesive-layer-attached polarizing film 10′ can be produced. The use of the separator SA₁′ for curl-adjustment instead of the separator SA₁ makes it possible to adjust the curl quantity of the double-sided pressure-sensitive-adhesive-layer-attached polarizing film 10′. It is preferred that this producing method is performed through a roll-to-roll manner bonding step (2), as illustrated in FIG. 7.

In FIG. 7, the double-sided pressure-sensitive-adhesive-layer-attached polarizing film 10 fed from a feeding-out roller is caused to perform a step (b) of peeling off the separator SA₁ by effect of a peeling roller R6. Next, the step (2) is performed which is a step of bonding the fed double-sided pressure-sensitive-adhesive-layer-attached polarizing film 13 and the separator SA₁′ for curl-adjustment to each other between paired bonding rolls R4 and R5. The resultant is then wound onto a winding roll to yield the double-sided pressure-sensitive-adhesive-layer-attached polarizing film 10′.

The peel strength a₁′ of the separator SA₁′ for curl-adjustment is preferably equivalent in numerical range to the peel strength a₁ of the separator SA₁. It is preferred from the viewpoint of curl quantity adjustment that the peel strength a₁′ and the peel strength b of the separator SB satisfy a relationship of a₁′>1.5b.

About the double-sided pressure-sensitive-adhesive-layer-attached polarizing film 10′ of the present invention, it is preferred in the roll-to-roll manner bonding step (2) that the ratio of the tensile strength T3 of the separator SA₁′ for curl-adjustment to that T4 of the double-sided pressure-sensitive-adhesive-layer-attached polarizing film 13, from which the separator SA₁ has been peeled off, (T3/T4) is controlled to 0.8 or more. In FIG. 7, the tensile strength T3 and that T4 can be controlled by effect of the rolls R13 and R14, respectively.

The control of the tensile strength ratio (T3/T4) into the range makes it possible to adjust the curl quantity. The tensile strength ratio (T3/T4) is preferably 0.9 or more, more preferably 1 or more, even more preferably 3 or more. In the meantime, if the tensile strength ratio (T3/T4) is too large, the curl quantity is too large, thereby in the step of the bonding onto a panel, the bonding precision is lowered. Thus, the tensile strength ratio (T3/T4) is preferably 10 or less, more preferably 6 or less, even more preferably 4 or less.

The tensile strength T3 is preferably from 8 to 500 N/m, more preferably from 50 to 300 N/m, even more preferably from 100 to 200 N/m.

The tensile strength T4 is preferably from 10 to 400 N/m, more preferably from 20 to 200 N/m, even more preferably from 40 to 100 N/m,

The degree of each of the tensile strengths is adjustable through, for example, the roll torque. The method for giving the tensile strength to the film or the other is not particularly limited. When the film or the other is fed out through one or more rolls, the tensile strength can be given thereto along the feeding-out direction. The tensile strength is measurable through a tension pickup roll of such a load cell type that the tensile strength can be measured on the basis of a load applied onto the feeding roll. The tensile strength is measured by a method described in the item “Examples”.

The method for producing the double-sided pressure-sensitive-adhesive-layer-attached polarizing film may include, after the above-mentioned steps, a step (c) of cutting the resultant film into any size, and a step (d) of cutting an edge of the double-sided pressure-sensitive-adhesive-layer-attached polarizing film obtained by the cutting. The cutting step (d) may be a polishing step.

### <Material of Pressure-Sensitive Adhesive Layer>

A material for forming each of the pressure-sensitive adhesive layers A and B in the present invention may be a material containing a base polymer that may be of various types. The type of the base polymer is not particularly limited, and examples thereof include rubber-based polymer, (meth)acryl-based polymer, silicone-based polymer, urethane-based polymer, vinyl alkyl ether-based polymer, polyvinyl alcohol-based polymer, polyvinyl pyrrolidone-based polymer, polyacrylamide-based polymer, and cellulose-based polymer.

It is preferred to use, out of these base polymers, any polymer that is excellent in optical transparency, and shows an appropriate wettability and adhesive properties of cohesiveness and adhesion to be excellent in weather resistance, heat resistance and other properties. A polymer showing such characteristics is preferably (meth)acryl-based polymer. Hereinafter, a description will be made about a material for forming the pressure-sensitive adhesive layers A and B, i.e., an acrylic pressure-sensitive adhesive containing, as a base polymer, a (meth)acryl-based polymer containing an alkyl (meth)acrylate as a monomer unit.

The (meth)acryl-based polymer is obtained by polymerizing one or more monomer components, the component(s) being/including an alkyl (meth)acrylate having an alkyl group of 4 to 24 carbon atoms at the ester end. As used herein, the term “alkyl (meth)acrylate” refers to alkyl acrylate and/or alkyl methacrylate, and “(meth)” is used in the same meaning in the description.

Examples of the alkyl (meth)acrylate include (meth)acrylates each having a linear or branched alkyl group of 4 to 24 carbon atoms. These alkyl (meth)acrylate may be used alone or in a mixture of two or more

The alkyl (meth)acrylate is, for example, an alkyl (meth)acrylate having a branched alkyl group of 4 to 9 carbon atoms. This alkyl (meth)acrylate is preferred since the resultant polymer easily takes a good balance between adhesive properties. Examples of the alkyl (meth)acrylate include n-butyl (meth)acrylate, s-butyl (meth)acrylate, t-butyl (meth)acrylate, isobutyl (meth)acrylate, n-pentyl (meth)acrylate, isopentyl (meth)acrylate, isohexyl (meth)acrylate, isoheptyl (meth)acrylate, 2-ethylhexyl (meth)acrylate, isooctyl (meth)acrylate, and isononyl (meth)acrylate. The (meth)acryl-based polymer for the pressure-sensitive adhesive layer A contains, as a monomer unit, 2-ethylhexyl acrylate in a most proportion from the viewpoint of the control of the storage modulus and the step-absorbing capability. When the pressure-sensitive adhesive layer A is a multiple pressure-sensitive adhesive layer containing at least a first pressure-sensitive adhesive layer (a) and a second pressure-sensitive adhesive layer (b), it is preferred about the multiple pressure-sensitive adhesive layer that its (meth)acryl-based polymer contains, as a monomer unit, 2-ethylhexyl acrylate in a most proportion (in the whole of the individual layers). In the meantime, it is preferred that the (meth)acryl-based polymer for the pressure-sensitive adhesive layer B contains, as a monomer unit, butyl acrylate in a most proportion to control the storage modulus of the pressure-sensitive adhesive layer B while the film satisfies workability, storability and durability.

In the present invention, the content of the above-mentioned alkyl (meth)acrylate having an alkyl group of 4 to 24 carbon atoms at the ester end is 40% by weight or more, preferably 50% by weight or more, more preferably 60% by weight or more based on the total weight of the monofunctional monomer component used to form the (meth)acryl-based polymer. The use thereof in the content of 40% or more by weight is preferred since the resultant polymer easily takes a good balance between adhesive properties.

The monomer components for forming the (meth)acryl-based polymer in the present invention may include, as a monofunctional monomer, a copolymerizable monomer other than the alkyl (meth)acrylate. The copolymerizable monomer is usable as a component other than the alkyl (meth)acrylate in the monomer components.

The copolymerizable monomers, for example, may include a cyclic nitrogen-containing monomer. Any monomer having a cyclic nitrogen structure and an unsaturated double bond-containing polymerizable functional group such as a (meth)acryloyl group or a vinyl group may be used without restriction as the cyclic nitrogen-containing monomer. The cyclic nitrogen structure preferably has a nitrogen atom in the cyclic structure. Examples of the cyclic nitrogen-containing monomer include vinyl lactam monomers such as N-vinylpyrrolidone, N-vinyl-Σ-caprolactam, and methylvinylpyrrolidone; and nitrogen-containing heterocyclic vinyl monomers such as vinylpyridine, vinylpiperidone, vinylpyrimidine, vinylpiperazine, vinylpyrazine, vinylpyrrole, vinylimidazole, vinyloxazole, and vinylmorpholine. The cyclic nitrogen-containing monomer may also be a (meth)acrylic monomer having a heterocyclic ring such as a morpholine ring, a piperidine ring, a pyrrolidine ring, or a piperazine ring. Examples include N-acryloyl morpholine, N-acryloyl piperidine, N-methacryloyl piperidine, and N-acryloyl pyrrolidine. Among them, vinyl lactam monomers are preferred, in view of dielectric constant and cohesiveness.

In the present invention, the content of the cyclic nitrogen-containing monomer is 45% by weight or less, more preferably from 0.5 to 40% by weight, even more preferably from 0.5 to 30% by weight based on the total weight of the monomer component used to form the (meth)acryl-based polymer. The use of the cyclic nitrogen-containing monomer in the range is preferred for the control of the surface resistance value of the pressure-sensitive-adhesive-layer-attached polarizing film and, in particular, the compatibility of the monomer with an ionic compound when this compound is used in any one of the pressure sensitive adhesive layers, and the durability of the antistatic function of the film.

The monomer component used to form the (meth)acryl-based polymer according to the invention may further include, as a monofunctional monomer, a hydroxyl group-containing monomer, a carboxyl group-containing monomer, and a cyclic ether group-containing monomer.

Any monomer having a hydroxyl group and an unsaturated double bond-containing polymerizable functional group such as a (meth)acryloyl group or a vinyl group may be used without restriction as the hydroxyl group-containing monomer. Examples of the hydroxyl group-containing monomer include hydroxyalkyl (meth)acrylate such as 2-hydroxyethyl (meth)acrylate, 2-hydroxypropyl (meth)acrylate, 2-hydroxybutyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, or 12-hydroxylauryl (meth)acrylate; and hydroxyalkylcycloalkane (meth)acrylate such as (4-hydroxymethylcyclohexyl)methyl (meth)acrylate. Other examples include hydroxyethyl(meth)acrylamide, allyl alcohol, 2-hydroxyethyl vinyl ether, 4-hydroxybutyl vinyl ether, and diethylene glycol monovinyl ether. These may be used alone or in any combination. Among them, hydroxyalkyl (meth)acrylate is preferred.

Any monomer having a carboxyl group and an unsaturated double bond-containing polymerizable functional group such as a (meth)acryloyl group or a vinyl group may be used without restriction as the carboxyl group-containing monomer. Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid. These may be used alone or in any combination. Itaconic acid or maleic acid can be used in the form of an anhydride. Among these, acrylic acid and methacrylic acid are preferred, and acrylic acid is particularly preferred. In the invention, a carboxyl group-containing monomer may be or may not be used as an optional monomer to produce the (meth)acryl-based polymer. An adhesive containing a (meth)acryl-based polymer obtained from a monomer component free of any carboxyl group-containing monomer can form a pressure-sensitive adhesive layer with reduced ability to corrode metals, because the ability to corrode metals would be due to any carboxyl group.

Any monomer having a cyclic ether group such as an epoxy group or an oxetane group and an unsaturated double bond-containing polymerizable functional group such as a (meth)acryloyl group or a vinyl group may be used without restriction as the cyclic ether group-containing monomer. Examples of the epoxy group-containing monomer include glycidyl (meth)acrylate, 3,4-epoxycyclohexylmethyl (meth)acrylate, and 4-hydroxybutyl(meth)acrylate glycidyl ether. Examples of the oxetane group-containing monomer include 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, and 3-hexyl-oxetanylmethyl (meth)acrylate. These monomers may be used alone or in any combination.

In the invention, the content of the hydroxyl group-containing monomer, carboxyl group-containing monomer, and cyclic ether group-containing monomer is preferably 30% by weight or less, more preferably 27% by weight or less, further preferably 25% by weight or less, based on the total weight of the monofunctional monomer component used to form the (meth)acryl-based polymer.

An example of one of the monomer components for forming the (meth)acryl-based polymer in the present invention is an alkyl (meth)acrylate, as the copolymerizable monomer, represented by CH₂═C(R¹) COOR² wherein R¹ represents hydrogen or a methyl group, and R² represents a unsubstituted or substituted alkyl group of 1 to 3 carbon atoms, or a cyclic alkyl group.

The unsubstituted or substituted alkyl group of 1 to 3 carbon atoms represented by R² may be a linear, or branched alkyl group. The substituted alkyl group preferably has an aryl group of 3 to 8 carbon atoms or an aryloxy group of 3 to 8 carbon atoms as a substituent. The aryl group is preferably, but not limited to, a phenyl group.

Examples of the monomer represented by CH₂═C(R¹)COOR² include methyl (meth)acrylate, ethyl (meth)acrylate, phenoxyethyl (meth)acrylate, benzyl(meth)acrylate, cyclohexyl (meth)acrylate, 3,3,5-trimethylcyclohexyl (meth)acrylate, and isobornyl (meth)acrylate. These monomers may be used alone or in any combination.

In the invention, the content of the (meth)acrylate represented by CH₂═C(R¹)COOR² may be 45% by weight or less, preferably 35% by weight or less, more preferably 30% by weight or less, based on the total weight of the monofunctional monomer component used to form the (meth)acryl-based polymer.

Other copolymerizable monomers that may also be used include vinyl acetate, vinyl propionate, styrene, α-methylstyrene; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate; amide group-containing monomers, amino group-containing monomers, imide group-containing monomers, N-acryloyl morpholine, and vinyl ether monomers. Cyclic structure-containing monomers such as terpene (meth)acrylate and dicyclopentanyl (meth)acrylate may also be used as copolymerizable monomers.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

The copolymerizable monomer is appropriately selectable when the (meth)acryl-based polymer, which is a base polymer, is prepared in the formation of each of the pressure-sensitive adhesive layers A and B. When the first pressure-sensitive adhesive layer (a) in the pressure-sensitive adhesive layer A, and the pressure-sensitive adhesive layer B are made of an acrylic pressure-sensitive adhesive, at least one of these layers preferably contains, as a monomer unit, at least one of (meth)acrylic acid and a nitrogen-containing monomer in view of improving cohesive strength, adhesive strength, transparency and durability.

In the invention, if necessary, the monomer component used to form the (meth)acryl-based polymer may contain a polyfunctional monomer for controlling the cohesive strength of the pressure-sensitive adhesive in addition to the monofunctional monomers listed above.

The polyfunctional monomer is a monomer having at least two polymerizable functional groups with an unsaturated double bond such as (meth)acryloyl group or vinyl group, and examples thereof include ester compounds of a polyhydric alcohol with (meth)acrylic acid such as (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, propoxylated pentaerythritol triacrylate, dipentaerythritol hexa(meth)acrylate, 1,2-ethyleneglycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate; allyl (meth)acrylate, vinyl (meth)acrylate, divinylbenzene, epoxy acrylate, polyester acrylate, urethane acrylate, butanediol di(meth)acrylate, hexanediol di(meth)acrylate, and the like.

Among them, trimethylolpropane tri(meth)acrylate, hexanediol di(meth)acrylate, and dipentaerythritol hexa(meth)acrylate can be preferably used. The polyfunctional monomer can be used alone or in combination of two or more.

The use amount of the polyfunctional monomer is varied in accordance with the molecular weight thereof and the number of functional groups thereof, and is preferably 3 parts by weight or less, more preferably 2 parts by weight or less, even more preferably 1 part by weight or less based on 100 parts by weight of the whole of the monofunctional monomer(s). The low limit value thereof is not particularly limited, and is preferably 0 part by weight or more, more preferably 0.001 part by weight or more. When the use amount of the polyfunctional monomer is in the range, the layers can be improved in adhering strength.

The (meth)acryl-based polymer described above can be produced using a method appropriately selected from known production methods, such as solution polymerization, radiation polymerization such as ultraviolet ray polymerization, bulk polymerization, and various radical polymerization methods including emulsion polymerization. The resultant (meth)acryl-based polymer may be any of a random copolymer, a block copolymer, a graft copolymer, or any other form.

Any appropriate polymerization initiator, chain transfer agent, emulsifying agent and so on may be selected and used for radical polymerization. The weight average molecular weight of the (meth)acryl-based polymer may be controlled by the reaction conditions including the amount of addition of the polymerization initiator or the chain transfer agent. The amount of the addition may be controlled as appropriate depending on the type of these materials.

In a solution polymerization process and so on, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Examples of the thermal polymerization initiator used for the solution polymerization process include, but are not limited to, azo initiators such as 2,2′-azobisisobutyronitrile, 2,2′-azobis-2-methylbutyronitrile, 2,2′-azobis(2-methylpropionic acid) dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total content of the polymerization initiator(s) is preferably from about 0.005 to 1 part by weight, even more preferably from about 0.02 to about 0.5 parts by weight, based on 100 parts by total weight of the monomer component.

For example, when 2,2′-azobisisobutyronitrile is used as a polymerization initiator for the production of the (meth)acryl-based polymer with the above weight average molecular weight, the polymerization initiator is preferably used in a content of from about 0.06 to about 0.2 parts by weight, more preferably of from about 0.08 to about 0.175 parts by weight, based on 100 parts by total weight of the monomer component.

Examples of the chain transfer agent include lauryl mercaptan, glycidyl mercaptan, mercaptoacetic acid, 2-mercaptoethanol, thioglycolic acid, 2-ethylhexyl thioglycolate and 2,3-dimercapto-1-propanol. One of these chain transfer agents may be used alone, or two or more thereof may be used in a mixture. The total content of the chain transfer agent(s) is preferably about 0.1 parts by weight or less, based on 100 parts by total weight of the monomer component.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by ADEKA CORPORATION). The reactive emulsifier is preferred, because after polymerization, it can be incorporated into a polymer chain to improve water resistance. Based on 100 parts by total weight of the monomer component, the emulsifier is preferably used in a content of 0.3 to 5 parts by weight, more preferably of 0.5 to 1 part by weight, in view of polymerization stability or mechanical stability.

When the (meth)acryl-based polymer is produced by active energy ray polymerization, the production can be attained by irradiating the monomer component(s) with an active energy ray, such as an electron beam or an ultraviolet ray, to be polymerized. When the active energy ray polymerization is attained using the electron beam, it is not particularly necessary to incorporate a photopolymerization initiator into the monomer component(s). When the active energy ray polymerization is attained through the ultraviolet ray polymerization, a photopolymerization initiator may be incorporated into the monomer component(s) to produce, particularly, an advantage of shortening the polymerization period, and/or some other advantage. The photopolymerization initiator may be used alone or in a mixture of two or more. About the monomer component(s), a part thereof may be beforehand polymerized to be made into a syrup, and in the irradiation with the radial ray, the syrup is usable.

The photopolymerization initiator is not particularly limited as long as it can initiate photopolymerization, and photopolymerization initiators that are usually used can be employed. Examples thereof that can be used include benzoin ether-based photopolymerization initiator, acetophenone-based photopolymerization initiator, α-ketol-based photopolymerization initiator, aromatic sulfonyl chloride-based photopolymerization initiator, photoactive oxime-based photopolymerization initiator, benzoin-based photopolymerization initiator, benzyl-based photopolymerization initiator, benzophenone-based photopolymerization initiator, ketal-based photopolymerization initiator, thioxanthone-based photopolymerization initiator, acylphosphine oxide-based photopolymerization initiator, and the like.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (trade name: IRGACURE 651, manufactured by BASF), anisoin methyl ether, and the like. Examples of the acetophenone-based photopolymerization initiator include 1-hydroxycyclohexyl phenyl ketone (trade name: IRGACURE 184, manufactured by BASF), 4-phenoxydichloroacetophenone, 4-t-butyl-dichloroacetophenone, 1-[4-(2-hydroxyethoxy)-phenyl]-2-hydroxy-2-methyl-1-propan-1-one (trade name: IRGACURE 2959, manufactured by BASF), 2-hydroxy-2-methyl-1-phenyl-propan-1-one (trade name: DAROCUR 1173, manufactured by BASF), methoxyacetophenone, and the like. Examples of the α-ketol-based photopolymerization initiator include 2-methyl-2-hydroxypropiophenone, 1-[4-(2-hydroxyethyl)-phenyl]-2-hydroxy-2-methylpropan-1-on e, and the like. Examples of the aromatic sulfonyl chloride-based photopolymerization initiator include 2-naphthalene sulfonyl chloride and the like. Examples of the photoactive oxime-based photopolymerization initiator include 1-phenyl-1,2-propanedione-2-(O-ethoxycarbonyl)-oxime, and the like.

Examples of the benzoin-based photopolymerization initiator include benzoin and the like. Examples of the benzyl-based photopolymerization initiator include benzyl and the like. Examples of the benzophenone-based photopolymerization initiators include benzophenone, benzoylbenzoic acid, 3,3′-dimethyl-4-methoxybenzophenone, polyvinylbenzophenone, α-hydroxycyclohexylphenylketone, and the like. Examples of the ketal-based photopolymerization initiator include benzyl dimethyl ketal and the like. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone and the like.

Examples of the acylphosphine oxide-based photopolymerization initiator include bis(2,6-dimethoxybenzoyl)phenylphosphine oxide, bis(2,6-dimethoxybenzoyl) (2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl) (2-methylpropan-1-yl)phosphine oxide, bis(2-methoxybenzoyl) (1-methylpropan-1-yl)phosphine oxide, bis(2,6-diethoxybenzoyl) (2-methylpropan-1-yl)phosphine oxide, bis(2,6-diethoxybenzoyl) (1-methylpropan-1-yl)phosphine oxide, bis(2,6-dibutoxybenzoyl) (2-methylpropan-1-yl)phosphine oxide, bis(2,4-dimethoxybenzoyl) (2-methylpropan-1-yl)phosphine oxide, bis(2,4,6-trimethylbenzoyl) (2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, and the like.

The content of the photopolymerization initiator is not particularly limited, but is preferably 0.01 to 5 parts by weight, more preferably 0.05 to 3 parts by weight, furthermore preferably 0.05 to 1.5 parts by weight, and particularly preferably 0.1 to 1 part by weight, based on 100 parts by total weight of the monomer component.

If the photopolymerization initiator is used in an amount of less than 0.01 parts by weight, the polymerization reaction may be insufficient. If the photopolymerization initiator is used in an amount of more than 5 parts by weight, the photopolymerization initiator may absorb ultraviolet rays, so that ultraviolet rays may fail to reach the inside of the pressure-sensitive adhesive layer. In this case, the degree of polymerization may decrease, or a polymer with a lower molecular weight may be produced. This may cause the resulting pressure-sensitive adhesive layer to have lower cohesive strength, so that in the process of peeling off the pressure-sensitive adhesive layer from a film, the pressure-sensitive adhesive layer may partially remain on the film, which may make it impossible to reuse the film. The photopolymerization initiators may be used singly or in combination of two or more.

In the invention, the (meth)acryl-based polymer preferably has a weight average molecular weight of 400,000 to 2,500,000, more preferably 600,000 to 2,200,000. When the weight average molecular weight is more than 400,000, the pressure-sensitive adhesive layer can have satisfactory durability and can have a cohesive strength small enough to suppress adhesive residue. On the other hand, if the weight average molecular weight is more than 2,500,000, bonding ability or adhesive strength may tend to be lower. In this case, the pressure-sensitive adhesive may form a solution with too high a viscosity, which may be difficult to apply. As used herein, the term “weight average molecular weight” refers to a polystyrene-equivalent weight average molecular weight, which is determined using gel permeation chromatography (GPC). It should be noted that the molecular weight of the (meth)acryl-based polymer obtained by radiation polymerization would be difficult to measure.

### <Measurement of Weight Average Molecular Weight>

The weight average molecular weight of the obtained (meth)acryl-based polymer was measured by gel permeation chromatography (GPC) as follows. The polymer sample was dissolved in tetrahydrofuran to forma 0.1% by weight solution. After allowed to stand overnight, the solution was filtered through a 0.45 μm membrane filter, and the filtrate was used for the measurement.

Analyzer: HLC-8120GPC manufactured by TOSOH CORPORATION

Columns:
(meth)acryl-based polymer: GM7000H_{XL}+GMH_{XL}+GMH_{XL}, manufactured by TOSOH CORPORATION,
aromatic-based polymer: G3000HXL+2000HXL+G1000HXL, manufactured by TOSOH CORPORATION

Column size: each 7.8 mmφ×30 cm, 90 cm in total

Eluent: tetrahydrofuran (concentration 0.1% by weight)

Flow rate: 0.8 ml/minute

Inlet pressure: 1.6 MPa

Detector: differential refractometer (RI)

Column temperature: 40° C.

Injection volume: 100 μl

Eluent: tetrahydrofuran

Detector: differential refractometer

Standard sample: polystyrene

The pressure-sensitive adhesive used to form the pressure-sensitive adhesive layer A, B of the present invention may contain a crosslinking agent. Examples of the crosslinking agents include an isocyanate crosslinking agent, an epoxy crosslinking agent, a silicone crosslinking agent, an oxazoline crosslinking agent, an aziridine crosslinking agent, a silane crosslinking agent, an alkyl etherified melamine crosslinking agent, a metallic chelate crosslinking agent and a peroxide. Such crosslinking agents may be used alone or in combination of two or more. An isocyanate crosslinking agent or an epoxy crosslinking agent is preferably used as the crosslinking agent.

These crosslinking agents may be used alone or in a mixture of two or more. The total content of the crosslinking agent (s) is preferably 0.01 to 5 parts by weight, more preferably 0.01 to 4 parts by weight, even more preferably 0.02 to 3 parts by weight, based on 100 parts by weight of the (meth)acryl-based polymer.

The term “isocyanate crosslinking agent” refers to a compound having two or more isocyanate groups (which may include functional groups that are temporarily protected with an isocyanate blocking agent or by oligomerization and are convertible to isocyanate groups) per molecule.

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane-tolylene diisocyanate trimer adduct (trade name: CORONATE L, manufactured by NIPPON POLYURETHANE INDUSTRY CO., LTD.), a trimethylolpropane-hexamethylene diisocyanate trimer adduct (trade name: CORONATE HL, manufactured by NIPPON POLYURETHANE INDUSTRY CO., LTD.), and an isocyanurate of hexamethylene diisocyanate (trade name: CORONATE HX, manufactured by NIPPON POLYURETHANE INDUSTRY CO., LTD.); a trimethylolpropane adduct of xylylene diisocyanate (trade name: D110N, manufactured by Mitsui Chemicals, Inc.) and a trimethylolpropane adduct of hexamethylene diisocyanate (trade name: D160N, manufactured by Mitsui Chemicals, Inc.); polyether polyisocyanate and polyester polyisocyanate; adducts thereof with various polyols; and polyisocyanates polyfunctionalized with an isocyanurate bond, a biuret bond, an allophanate bond, or the like. In particular, aliphatic isocyanates are preferably used because of their high reaction speed.

These isocyanate crosslinking agents may be used alone or in a mixture of two or more. The total content of the isocyanate crosslinking agent(s) is preferably 0.01 to 5 parts by weight, more preferably 0.01 to 4 parts by weight, further more preferably 0.02 to 3 parts by weight, based on 100 parts by weight of the (meth)acryl-based polymer. The content may be appropriately determined taking into account cohesive strength, the ability to prevent delamination in a durability test, or other properties.

When an aqueous dispersion of a modified (meth)acryl-based polymer produced by emulsion polymerization is used, the isocyanate crosslinking agent does not have to be used. If necessary, however, a blocked isocyanate crosslinking agent may also be used in such a case, because the isocyanate crosslinking agent itself can easily react with water.

The term “epoxy crosslinking agent” refers to a polyfunctional epoxy compound having two or more epoxy groups per molecule. Examples of the epoxy crosslinking agent include bisphenol A, epichlorohydrin-type epoxy resin, ethylene glycol diglycidyl ether, N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, glycerine diglycidyl ether, glycerine triglycidyl ether, polyglycerol polyglycidyl ether, sorbitan polyglycidyl ether, trimethylolpropane polyglycidyl ether, diglycidyl adipate, diglycidyl o-phthalate, triglycidyl tris(2-hydroxyethyl)isocyanurate, resorcin diglycidyl ether, bisphenol-S diglycidyl ether, and epoxy resins having two or more epoxy groups in the molecule. The epoxy crosslinking agent may also be a commercially available product such as TETRAD-C (trade name) or TETRAD-X (trade name) manufactured by MITSUBISHI GAS CHEMICAL COMPANY, INC.

These epoxy crosslinking agents may be used alone or in a mixture of two or more. The total content of the epoxy crosslinking agent(s) is preferably 0.01 to 5 parts by weight, more preferably 0.01 to 4 parts by weight, further more preferably 0.02 to 3 parts by weight, based on 100 parts by weight of the (meth)acryl-based polymer. The content may be appropriately determined taking into account cohesive strength, the ability to prevent delamination in a durability test, or other properties.

Any peroxide crosslinking agents capable of generating active radical species by heating and promoting the crosslinking of the base polymer in the pressure-sensitive adhesive may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

One of the peroxide crosslinking agents may be used alone, or a mixture of two or more of the peroxide crosslinking agent may be used. The total content of the peroxide (s) is preferably from 0.02 to 2 parts by weight, more preferably from 0.05 to 1 part by weight, based on 100 parts by weight of the (meth) acryl-based polymer. The content of the peroxide(s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

As the crosslinking agent, a polyfunctional metal chelate may also be used in combination with an organic crosslinking agent. Examples of the polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The pressure-sensitive adhesive that forms each of the pressure-sensitive adhesive layers A and B in the present invention may contain, as the crosslinking agent, a polyfunctional monomer. The polyfunctional monomer is a monomer having at least two polymerizable functional groups with an unsaturated double bond such as (meth)acryloyl group or vinyl group. Examples thereof are the same as given as the monomer component or one of the monomer components for forming the (meth)acryl-based polymer.

The polyfunctional monomers, as the crosslinking agent, may be used alone or in a mixture of two or more. The total content of the crosslinking agent(s) (polyfunctional monomer) is preferably from 0.001 to 5 parts by weight, more preferably from 0.005 to 3 parts by weight, even more preferably from 0.01 to 1 part by weight based on 100 parts by weight of the (meth)acryl-based polymer.

A photopolymerization initiator is blended into the pressure-sensitive adhesive into which the crosslinking agent (polyfunctional monomer) is blended. Examples of the photopolymerization initiator are the same as used to prepare the (meth)acryl-based polymer. The use amount of the photopolymerization initiator is usually from 0.01 to 5 parts by weight, preferably from 0.05 to 3 parts by weight, more preferably from 0.05 to 1.5 parts by weight, even more preferably from 0.1 to 1 part by weight based on 100 parts by weight of the crosslinking agent (polyfunctional monomer). The pressure-sensitive adhesive into which the crosslinking agent (polyfunctional monomer) is blended is irradiated with an active energy ray to be cured so that a pressure-sensitive adhesive layer (active-energy-ray-cured-pressure-sensitive adhesive layer) is formed.

About the multiple pressure-sensitive adhesive layer which is the pressure-sensitive adhesive layer A, at least one of the pressure-sensitive adhesive layers thereof is preferably an active-energy-ray-cured-pressure-sensitive adhesive layer formed by irradiation with an active energy ray since this layer can be formed with a predetermined thickness to give an advantage for the step-absorbing capability. The first pressure-sensitive adhesive layer (a) and/or the second pressure-sensitive adhesive layer (b) is/are in particular preferably one or two active-energy-ray-cured-pressure-sensitive adhesive layers.

The pressure-sensitive adhesive used to form the pressure-sensitive adhesive layer A, B of the present invention may contain a (meth)acryl-based oligomer in view of improving adhesive strength. The (meth)acryl-based oligomer is preferably a polymer having a Tg higher than that of the (meth)acryl-based polymer according to the invention and having a weight average molecular weight lower than that of the (meth)acryl-based polymer according to the invention. The (meth)acryl-based oligomer functions as a tackifying resin and is advantageous in increasing adhesive strength without raising dielectric constant.

The (meth)acryl-based oligomer may have a Tg of from about 0° C. to about 300° C., preferably from about 20° C. to about 300° C., more preferably from about 40° C. to about 300° C. If the Tg is lower than about 0° C., the pressure-sensitive adhesive layer may be lowered in cohesive strength at room temperature or higher so as to be lowered in holding performance or in tackiness at high temperatures. Like the Tg of the (meth)acryl-based polymer, the Tg of the (meth)acryl-based oligomer is the theoretical value calculated from the Fox equation.

The (meth)acryl-based oligomer may have a weight average molecular weight of 1,000 to less than 30,000, preferably 1,500 to less than 20,000, more preferably 2,000 to less than 10,000. If the oligomer has a weight average molecular weight of 30,000 or more, the effect of improving adhesive strength cannot be sufficiently obtained in some cases. The oligomer with a weight average molecular weight of less than 1,000 may lower the adhesive strength or holding performance because of its relatively low molecular weight. In the invention, the weight average molecular weight of the (meth)acryl-based oligomer can be determined as a polystyrene-equivalent weight average molecular weight by GPC method. More specifically, the weight average molecular weight can be determined using HPLC 8020 with two TSK gel GMH-H (20) columns manufactured by TOSOH CORPORATION under the conditions of a solvent of tetrahydrofuran and a flow rate of about 0.5 ml/minute.

Examples of monomers that may be used to form the (meth)acryl-based oligomer include alkyl (meth)acrylate such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl(meth)acrylate, isodecyl(meth)acrylate, undecyl (meth)acrylate, or dodecyl (meth)acrylate; an ester of (meth)acrylic acid and an alicyclic alcohol, such as cyclohexyl (meth)acrylate, isobornyl (meth)acrylate or dicyclopentanyl (meth)acrylate; aryl (meth)acrylate such as phenyl (meth)acrylate or benzyl (meth)acrylate; and a (meth)acrylate derived from a terpene compound derivative alcohol. These (meth)acrylates may be used alone or in combination of two or more.

The (meth)acryl-based oligomer preferably contains, as a monomer unit, an acrylic monomer having a relatively bulky structure, typified by an alkyl (meth)acrylate whose alkyl group has a branched structure, such as isobutyl (meth)acrylate or tert-butyl (meth)acrylate; an ester of (meth)acrylic acid and an alicyclic alcohol, such as isobornyl (meth)acrylate or dicyclopentanyl (meth)acrylate; or aryl (meth)acrylate such as phenyl (meth)acrylate or benzyl (meth)acrylate, or any other cyclic structure-containing (meth)acrylate. The use of a (meth)acryl-based oligomer with such a bulky structure can further improve the tackiness of the pressure-sensitive adhesive layer. In terms of bulkiness, cyclic structure-containing oligomers are highly effective, and oligomers having two or more rings are more effective. When ultraviolet light is used in the process of synthesizing the (meth)acryl-based oligomer or forming the pressure-sensitive adhesive layer, a saturated oligomer is preferred because such an oligomer is less likely to inhibit polymerization, and an alkyl (meth)acrylate whose alkyl group has a branched structure or an ester of an alicyclic alcohol and (meth)acrylic acid is preferably used as a monomer to form the (meth)acryl-based oligomer.

From these points of view, preferred examples of the (meth)acryl-based oligomer include a copolymer of cyclohexyl methacrylate (CHMA) and isobutyl methacrylate (IBMA), a copolymer of cyclohexyl methacrylate (CHMA) and isobornyl methacrylate (IBXMA), a copolymer of cyclohexyl methacrylate (CHMA) and acryloyl morpholine (ACMO), a copolymer of cyclohexyl methacrylate (CHMA) and diethylacrylamide (DEAA), a copolymer of 1-adamanthyl acrylate (ADA) and methyl methacrylate (MMA), a copolymer of dicyclopentanyl methacrylate (DCPMA) and isobornylmethacrylate (IBXMA), a copolymer of dicyclopentanyl methacrylate (DCPMA) and methyl methacrylate (MMA), and a homopolymer of each of dicyclopentanyl methacrylate (DCPMA), cyclohexylmethacrylate (CHMA), isobornylmethacrylate (IBXMA), isobornyl acrylate (IBXA), dicyclopentanyl acrylate (DCPA), 1-adamanthyl methacrylate (ADMA), and 1-adamanthyl acrylate (ADA). In particular, an oligomer composed mainly of CHMA is preferred.

In the pressure-sensitive adhesive used to form the pressure-sensitive adhesive layer A, B of the present invention, the content of the (meth)acryl-based oligomer is preferably, but not limited to, 70 parts by weight or less, more preferably from 1 to 70 parts by weight, even more preferably from 2 to 50 parts by weight, still more preferably from 3 to 40 parts by weight, based on 100 parts by weight of the (meth)acryl-based polymer. If the content of the (meth)acryl-based oligomer is more than 70 parts by weight, a problem may occur such as an increase in elastic modulus or a decrease in tackiness at low temperature. Adding 1 part by weight or more of the (meth)acryl-based oligomer is effective in improving adhesive strength.

The pressure-sensitive adhesive used to form the pressure-sensitive adhesive layer A, B of the present invention may further contain a silane coupling agent for improving water resistance at the interface between the pressure-sensitive adhesive layer and a hydrophilic adherend, such as glass, bonded thereto. The content of the silane coupling agent is preferably 1 part by weight or less, more preferably from 0.01 to 1 part by weight, even more preferably from 0.02 to 0.6 parts by weight, based on 100 parts by weight of the (meth)acryl-based polymer. If the content of the silane coupling agent is too high, the adhesive may have a higher adhesive strength to glass so that it may be less removable from glass. If the content of the silane coupling agent is too low, the durability of the adhesive may undesirably decrease.

Examples of silane coupling agent preferably can be used include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, 3-triethoxysilyl-N-(1,3-dimethylbutylidene)propylamine and N-phenyl-γ-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

The pressure-sensitive adhesive used to form the pressure-sensitive adhesive layer A, B of the present invention may also contain any other known additive. For example, a polyether compound such as a polyalkylen glycol exemplified a polypropylene glycol, a powder such as a colorant and a pigment, a dye, a surfactant, a plasticizer, a tackifier, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range.

For example, the pressure-sensitive adhesive layers A, B may be formed by a method including applying the formation material (pressure-sensitive adhesive) to a member such as a transparent substrate and/or a polarizing film, removing the polymerization solvent and so on by drying to form a pressure-sensitive adhesive layers. Before the formation material is applied, appropriately at least one solvent other than the polymerization solvent may be added to the formation material.

Various methods may be used to apply the formation material. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The heat drying temperature is preferably from 40° C. to 200° C., more preferably from 50° C. to 180° C., in particular, preferably from 70° C. to 170° C. Setting the heating temperature within the above range makes it possible to obtain a pressure-sensitive adhesive layer A or B having good adhesive properties. The drying time may be any appropriate period of time. The drying time is preferably from 5 seconds to 20 minutes, more preferably from 5 seconds to 10 minutes, in particular, preferably from 10 seconds to 5 minutes.

When the formation material (pressure-sensitive adhesive) is an active-energy-ray-curable-pressure-sensitive adhesive, the formation of the pressure-sensitive adhesive layers A and B can be attained by irradiating the material with an active energy ray, such as an ultraviolet ray, to be polymerized. For the ultraviolet irradiation, for example, a high-pressure mercury lamp, a low-pressure mercury lamp, or a metal halide lamp is usable.

The pressure-sensitive adhesive layers A and B may be formed onto a support, and then transferred onto, for example, a polarizing film. The support may be, for example, a release-treated sheet. A silicone release liner is preferably used as the release-treated sheet. When the pressure-sensitive adhesive layer A is the multiple pressure-sensitive adhesive layer, the multiple pressure-sensitive adhesive layer may be formed successively onto the release-treated sheet, and the resultant may be bonded onto a polarizing film. Alternatively, the first and second pressure-sensitive adhesive layers (a) and (b), and others that are separately formed may be successively formed onto a polarizing film to position the first pressure-sensitive adhesive layer (a) to give an outermost surface of the resultant.

The release-treated sheet is a separator to be usable as the separator SA₁ of the pressure-sensitive adhesive layer A, or the separator SB of the pressure-sensitive adhesive layer B. When the double-sided pressure-sensitive-adhesive-layer-attached polarizing film of the present invention is practically used, the release-treated sheet is peeled off.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer A or B, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

For each of the separators, as a substrate film thereof, the plastic film is used. As required, the separator may be subjected to a release treatment or stain resistance treatment with a release agent of, e.g., a silicone, fluorine-containing, long-chain alkyl or aliphatic acid amide type, or with silica powder, or to an antistatic treatment of, e.g., a painting, kneading-in or vapor-depositing type. The separator can be heightened in release performance from the pressure-sensitive adhesive layer A or B, in particular, by subjecting the surface of the separator appropriately to a release treatment such as silicone treatment, long-chain alkyl treatment or fluorine treatment.

For a silicone release layer formed by the silicon treatment may be, for example, an addition reaction type silicone resin is usable. Examples thereof include products KS-774, KS-775, KS-778, KS-779H, KS-847H, and KS-847T manufactured by Shin-Etsu Chemical Co., Ltd.; ones TPR-6700, TPR-6710, and TPR-6721 manufactured by Toshiba Silicones Co., Ltd.; and ones SD7220 and SD7226 manufactured by Dow Corning Toray Co., Ltd. The paint amount of the silicone release layer (after the layer is dried) is preferably from 0.01 to 2 g/m², more preferably from 0.01 to 1 g/m², even more preferably from 0.01 to 0.5 g/m².

The release layer can be formed, for example, by painting the above-mentioned material onto an oligomer preventing layer in a coating manner known in the prior art, such as reverse gravure coating, bar coating or die coating, and then subjecting the resultant to heat treatment usually at about 120 to 200° C. to be cured. As required, the heat treatment may be conducted together with active energy ray radiation, such as ultraviolet ray radiation.

The thickness of each of the separators (which includes the thickness of the release layer) is usually from about 5 to 200 μm. The thickness of the separator is related to the peel strength thereof; thus, it is preferred to adopt a thickness corresponding to the separator. The thickness of each of the separators SA₁, SA₁′ and SA₂ is preferably 30 μm or more, more preferably 40 μm or more, even more preferably 50 μm or more from the viewpoint of the peel strength and the prevention of bruises. For details, the thickness of each of the separators SA₁, SA₁′ and SA₂ is preferably from 40 to 130 μm, more preferably from 50 to 80 μm. The thickness of the separator SB is preferably from 10 to 80 μm, more preferably from 20 to 50 μm, even more preferably from 30 to 50 μm, even more preferably from 30 to 40 μm. In the structure of the double-sided pressure-sensitive-adhesive-layer-attached polarizing film, about the thickness of the separators, it is particularly preferred from the viewpoint of the peel strength and the prevention of bruises to combine a case where the thickness of the separator SA₁ (or SA′) is 50 μm or more with a case where that of the separator SB is from 30 to 50 μm.

When the pressure-sensitive adhesive layers A and B are located onto the polarizing film, one or each of the two surfaces of the polarizing film may be subjected to adhesion-facilitating treatment. Examples of the adhesion-facilitating treatment include corona treatment, plasma treatment, excimer treatment, hard coat treatment, and under-coating treatment. One or each of the two surfaces of anyone of the pressure-sensitive adhesive layers may be subjected to adhesion-facilitating treatment. In the pressure-sensitive-adhesive-layer-attached polarizing film of the present invention, the surface of its polarizing film onto which the pressure-sensitive adhesive layer A is to be laminated is preferably subjected to adhesion-facilitating treatment from the viewpoint of a restraint of the generation of foam and peeling.

The pressure-sensitive-adhesive-layer-attached polarizing film of the present invention may be prepared to have, at any moiety thereof, an antistatic function. The antistatic function can be given to the pressure-sensitive-adhesive-layer-attached polarizing film, for example, by incorporating, into its polarizing film or pressure-sensitive adhesive layer(s), an antistatic agent, or by laying an antistatic layer separately from its polarizing film or pressure-sensitive adhesive layers.

The antistatic layer may be arranged in an image display device (for example, a liquid crystal display device), and at a viewer-side thereof and outside (viewer-side) the polarizing film which is provided nearest to a viewer-side of an image display device among at least one polarizing film used in the device. Accordingly, for example, the following problem of a fall in optical properties of the device can be largely overcome: a problem that the cancelling of light polarization, or impurity-based bright spots that may be generated when an antistatic layer (low-surface-resistance layer) between the viewer-side polarizing film and a panel of the liquid crystal. Thus, the reliability of the polarizing film arranged at the viewer-side and at the outermost position of the device is not damaged. In such a way, the invention makes it possible to give an antistatic function to an image display device without damaging performance thereof.

In the case of applying the present invention to an in-cell or on-cell touch-sensor-built-in liquid crystal display device, the invention is particularly effective. Thus, the invention makes it possible to heighten the quality of any in-cell or on-cell touch-sensor-built-in liquid crystal display device.

In order to give antistatic function to the pressure-sensitive adhesive that forms the pressure-sensitive adhesive layers A and B in the present invention, an ionic compound as an antistatic agent is incorporated, together with the base polymer, into the adhesive. The ionic compound is preferably an alkali metal salt and/or an organic-cation/anion salt. The alkali metal salt may be an organic salt or inorganic salt of an alkali metal. The “organic-cation/anion salt” referred to in the present invention denotes an organic salt in which a cation moiety is made of an organic substance and an anion moiety is made of an organic or inorganic substance. The “organic-cation/anion salt” may be referred to as an ionic liquid or ionic solid.

The ionic compound may be an inorganic salt, such as ammonium chloride, aluminum chloride, copper chloride, ferrous chloride, ferric chloride, or ammonium sulfate, besides the alkali metal salt or organic-cation/anion salt. These ionic compounds may be singly used, or may be used in combination of two or more thereof.

The amount of the ionic compound in the pressure-sensitive adhesive for forming each of the pressure-sensitive adhesive layers A and B in the present invention is preferably from 0.0001 to 5 parts by weight based on 100 parts by weight of the (meth)acryl-based polymer. If the amount of the ionic compound is less than 0.0001 part by weight, the layer may not have a sufficient antistatic effect. The amount of the ionic compound is preferably 0.01 part by weight or more, more preferably 0.1 part by weight or more. In the meantime, if the amount of the ionic compound is more than 5 parts by weight, the layer may not have a sufficient durability. The amount of the ionic compound is preferably 3 parts by weight or less, more preferably 1 part by weight or less. The content of the ionic compound can be set into a preferred range by adopting the upper limit or lower limit value.

### EXAMPLES

Hereinafter, the present invention will be specifically described by way of working examples thereof. However, the invention is not limited by the examples. In each of the examples, the wording “part (s)” and the symbol “%” represent part (s) by weight and % by weight, respectively. The following estimations were made on each of the items in Examples and so on.

### <Production of Polarizing Film>

An 80 μm-thick polyvinyl alcohol film was stretched to 3 times between rolls different in velocity ratio, while it was dyed in a 0.3% iodine solution at 30° C. for 1 minute. The film was then stretched to a total stretch ratio of 6 times, while it was immersed in an aqueous solution containing 4% of boric acid and 10% of potassium iodide at 60° C. for 0.5 minutes. The film was then washed by immersion in an aqueous solution containing 1.5% of potassium iodide at 30° C. for 10 seconds and then dried at 50° C. for 4 minutes to give a polarizer with a thickness of 20 μm. A 40 μm thick saponified triacetylcellulose film and a 20 μm thick acrylic film were bonded to both sides of the polarizer with a polyvinyl alcohol adhesive to form a polarizing film. The surface (at the triacetylcellulose film side) of the polarizing film onto which the pressure-sensitive adhesive layer B was to be bonded was appropriately subjected to corona treatment.

### <Separator SA₁>

The following was used: a release film obtained by laying a release layer described below onto a polyethylene terephthalate film having a thickness of 38 μm, 50 μm or 75 μm.

### <Separator SA₁Y>

The following was used: a release film obtained by laying a release layer described below onto a polyethylene terephthalate film having a thickness of 50 μm.

### <Separator SA₂>

The following was used: a release film obtained by laying a release layer described below onto a polyethylene terephthalate film having a thickness of 50 μm.

### <Separator SB>

The following was used: a release film obtained by laying a release layer described below onto a polyethylene terephthalate film having a thickness of 38 μm, 50 μm or 75 μm.

### <<Release Layer>>

The following was used as the release layer of each of the separators:

A release layer obtained by diluting 20 parts by weight of a silicone resin (KS-847H, manufactured by Shin-Etsu Chemical Co., Ltd.), and 0.2 part by weight of a curing agent (PL-50T, manufactured by Shin-Etsu Chemical Co., Ltd.) with 350 parts by weight of a mixed solvent of methyl ethyl ketone and toluene (mixing ratio: 1/1) to prepare a silicone release agent solution; using a gravure coater to apply this silicone release agent solution onto each of the above-mentioned polyethylene terephthalate films (substrate films) to give a thickness of 100 nm after the applied layer would be dried; and then drying the applied layer at 120° C. This release layer was formed to yield each of the above-mentioned separators each having a structure of “substrate film/release layer”.

### Production Example 1

### Preparation of Formation Material for Pressure-Sensitive Adhesive Layers A

Into a four-necked flask equipped with stirring blades, a thermometer, a nitrogen gas introducing pipe and a condenser were charged 70 parts of 2-ethylhexyl acrylate (2EHA), 15 parts of N-vinylpyrrolidone (NVP), 15 parts of 4-hydroxybutyl acrylate (4HBA), and two photopolymerization initiators (trade names: IRGACURE 184, and IRGACURE 651, each manufactured by the company BASF), the amount of each of the two initiators being 0.05 part, to prepare a monomer mixture. Next, the monomer mixture was exposed to ultraviolet rays in a nitrogen atmosphere to be partially photopolymerized, thereby yielding a partially polymerized product (acryl-based polymer syrup) having a polymerization rate of about 10%.

Next, 0.01 part of trimethylolpropane triacrylate (TMPTA) was added to 100 parts of the acryl-based polymer syrup, and then these components were mixed with each other into a homogenous form to prepare a formation material (monomer component: A1) for some pressure-sensitive adhesive layers A.

### Production Examples 2 to 5

In each of the production examples, a formation material (monomer component: A2 to A5) for some pressure-sensitive adhesive layers A was prepared by making the same operations as made in Production Example 1 except that the composition of the individual components used to prepare the monomer components was changed to a composition shown in Table 1.

TABLE 1

| | Pressure-sensitive | Monomer components | | | |
|---|---|---|---|---|---|
| | adhesive layer A | (part(s) by weight) | | | |
| | formation material | 2EHA | NVP | 4HBA | TMPTA |
| Production | A1 | 70 | 15 | 15 | 0.01 |
| Example 1 | | | | | |
| Production | A2 | 70 | 15 | 15 | 0.005 |
| Example 2 | | | | | |
| Production | A3 | 70 | 15 | 15 | 0.02 |
| Example 3 | | | | | |
| Production | A4 | 70 | 15 | 15 | 0.002 |
| Example 4 | | | | | |
| Production | A5 | 70 | 15 | 15 | 0.1 |
| Example 5 | | | | | |

In Table 1, 2EHA represents 2-ethyl-hexyl acrylate;

NVP, N-vinylpyrrolidone;

4HBA, 4-hydroxybutyl acrylate; and

TMPTA, trimethylolpropane triacrylate.

### <Formation of Double-Sided Separator-Attached Pressure-Sensitive Adhesive Layer A>

One of the pressure-sensitive adhesive layer A formation materials (monomer components) prepared in Production Examples described above, the one forming material being shown in Table 2 or 3, was applied onto the release-treated surface of one of the separators SA₁ that is shown in Table 2 or 3 to give a final thickness of 50 μm, 100 μm, 200 μm or 300 μm to form a painted layer. Next, the outer surface of the applied monomer components was covered with the separator SA₂ shown in Table 2 or 3 to position the release-treated surface of this film at the painted layer side of the workpiece. In this way, the applied layer of the monomer components was blocked from oxygen. A chemical lamp (manufactured by Toshiba Corp.) was used to radiate ultraviolet rays onto the applied-layer-having sheet as described above at an illuminance of 5 mW/cm² (which was measured with a product, TOPCON UVR-T1, having a maximum sensitivity at about 350 nm) for 360 seconds to cure the applied layer, thereby forming a pressure-sensitive adhesive layer A to produce each double-sided separator-attached pressure-sensitive adhesive layer A.

### <Preparation of Pressure-Sensitive Adhesive Layer B Forming Pressure-Sensitive Adhesive>

Into a separable flask equipped with a thermometer, a stirrer, a reflux condenser and a nitrogen gas introducing pipe were charged 99 parts of butyl acrylate (BA) and 1 part of 4-hydroxybutyl acrylate (4HBA) as monomer components, 0.2 part of azoisobutyronitrile as a polymerization initiator, and ethyl acetate as a polymerizing solvent, the volume of which was a volume for setting the solid concentration in the solution into 30%. Thereafter, nitrogen gas was caused to flow into the pipe, and then the flask was purged with nitrogen for about 1 hour while the solution was stirred. The flask was then heated to 60° C. to cause the components to react with each other for 7 hours to yield an acryl-based polymer having a weight-average molecular weight (Mw) of U.S. Pat. No. 1,100,000. To the acryl-based polymer solution (solid content: 100 parts) were added 0.1 part of trimethylolpropanexylylene diisocyanate (“TAKENATE D110N”, manufactured by Mitsui Chemicals, Inc.) as an isocyanate crosslinking agent, and 0.1 part of a silane coupling agent (“KBM-403”, manufactured by Shin-Etsu Chemical Co., Ltd.) to prepare a pressure-sensitive adhesive composition (solution).

### <Formation of Separator-Attached Pressure-Sensitive Adhesive Layer B>

The prepared pressure-sensitive adhesive solution was applied onto the release-treated surface of the separator SB that is shown in Table 2 or 3 to give a thickness of 20 μm after the solution would be dried. Under a normal pressure, the workpiece was heated and dried at 60° C. for 3 minutes and at 120° C. for 3 minutes, and further aged at 23° C. for 120 hours to give a pressure-sensitive adhesive layer B.

### <Formation of Single-Sided Pressure-Sensitive-Adhesive-Layer-B-Attached Polarizing Film>

One of the separator-SB-attached pressure-sensitive adhesive Layers B was transferred onto one surface (at the triacetylcellulose film side) of one of the above-mentioned polarizing films to form each single-sided pressure-sensitive-adhesive-layer-B-attached polarizing film.

### Example 1

### Production of Double-Sided Pressure-Sensitive-Adhesive-Layer-Attached Polarizing Film

The machine shown in FIG. 6 was used.

The double-sided separator-attached pressure-sensitive adhesive layer A to be used in Example 1 (see Table 2) was fed out from one of the feeding rolls. Furthermore, the peeling roll was used to peel off the separator SA₂ and then the separator-SA₁-attached pressure-sensitive adhesive layer A was fed. The paired rolls were used to bond this separator-SA₁-attached pressure-sensitive adhesive layer A in a roll-to-roll manner onto the polarizing film side (acrylic film side) of the single-sided pressure-sensitive-adhesive-layer-B-attached polarizing film to be used in Example 1 fed separately from the other feeding-out roll to produce each double-sided pressure-sensitive-adhesive-layer-attached polarizing film. At the time of the bonding, the tensile strength T1 of the single-sided separator-attached pressure-sensitive adhesive layer A and that T2 of the single-sided pressure-sensitive-adhesive-layer-B-attached polarizing film were controlled as shown in Table 2.

In the production of the double-sided pressure-sensitive-adhesive-layer-attached polarizing film, the respective thicknesses of the separators SA₁, SA₂ and SB, and the peel strength a₁ of the separator SA₁, that a₂ of the separator SA₂, and that b of the separator SB are as shown in Table 1.

The surface (triacetylcellulose film side) of the polarizing film onto which the pressure-sensitive adhesive layer B was to be bonded was a corona-treated surface.

The thickness of the pressure-sensitive adhesive layer A is as shown in Table 1.

### <Measurement of Tensile Strengths>

Each of the tensile strengths was obtained by measuring the 1 m-width converted stress of the corresponding sample, using a detecting roll equipped with an MB tension sensor manufactured by Nireco Corp.

### Examples 2 to 13, and Comparative Examples 1 to 5

In each of the examples, each double-sided pressure-sensitive-adhesive-layer-attached polarizing film was produced by making the same operations as made in Example 1 except that some of the following were changed as shown in Table 2:

the respective thicknesses of the separators SA₁, SA₂ and SB;

the peel strength a₁ of the separator SA₁, that a₂ of the separator SA₂, and that b of the separator SB;

the thickness of the pressure-sensitive adhesive layer A, and the storage modulus of the pressure-sensitive adhesive layer A (the type of the pressure-sensitive adhesive layer);

a matter as to whether or not the surface of the polarizing film onto which the pressure-sensitive adhesive layer A was to be bonded was subjected to corona treatment; and

the tensile strength T1 of the single-sided separator-attached pressure-sensitive adhesive layer A, and that T2 of the single-sided pressure-sensitive-adhesive-layer-B-attached polarizing film.

However, in each of Comparative Examples 1 and 2, without using any roll-to-roll manner, a one-piece/one-piece film bonding machine manufactured by Sun-Tec Co., Ltd. was used to bond the single-sided pressure-sensitive-adhesive-layer-B-attached polarizing film and the separator-SA₁-attached pressure-sensitive adhesive layer A, which were each prepared for the comparative example, to each other, using a bonding area of 500 mm×400 mm that had long sides along the absorption axis.

### Example 14

### Production of Each Double-Sided Pressure-Sensitive-Adhesive-Layer-Attached Polarizing Film

The machine shown in FIG. 7 was used.

One of the same double-sided pressure-sensitive-adhesive-layer-attached polarizing films as obtained in Comparative Example 3 was fed out from one of the feeding-out rolls, and further the peeling roll was used to peel off the separator SA₁ and then this separator-SA₁-peeled double-sided pressure-sensitive-adhesive-layer-attached polarizing film was fed.

The paired rolls were used to bond a separator SA₁ for curl-adjustment that was fed out separately from the other feeding roll in a roll-to-roll manner onto the pressure-sensitive adhesive layer A of the double-sided pressure-sensitive-adhesive-layer-attached polarizing film to produce each double-sided pressure-sensitive-adhesive-layer-attached polarizing film. At the time of the bonding, the tensile strength T3 of the separator SA₁′ for curl-adjustment and that T4 of the separator-SA₁-peeled double-sided pressure-sensitive-adhesive-layer-attached polarizing film were controlled as shown in Table 3.

In the double-sided pressure-sensitive-adhesive-layer-attached polarizing film, the thickness of the separators SA₁′, and the peel strength a₁′ of the separator SA₁′ are as shown in Table 3.

### Comparative Example 6

Each double-sided pressure-sensitive-adhesive-layer-attached polarizing film was produced by performing the same operations as made in Example 14 except that the double-sided pressure-sensitive-adhesive-layer-attached polarizing film fed out from the feeding-out roll was changed (from the same film as in Comparative Example 3 to the same film as in Example 2), and further the tensile strength T3 of the separator SA₁′ for curl-adjustment and that T4 of the separator-SA₁-peeled double-sided pressure-sensitive-adhesive-layer-attached polarizing film were changed as shown in Table 3.

Evaluations as described below were made about some of the double-sided pressure-sensitive-adhesive-layer-attached polarizing films obtained in each of Production Examples, Examples and Comparative Examples described above. The evaluation results are shown in Tables 2 and 3.

### <Measurement of Shear Storage Modulus>

The shear storage modulus at 23° C. of each of the pressure-sensitive adhesive layers A and B of the measuring sample was obtained by dynamic viscoelasticity measurement. A dynamic viscoelascity measuring instrument (instrument name: “ARES”, manufactured by a company, TA Instruments) was used to measure the pressure-sensitive adhesive layers A and B of the measuring sample at a frequency of 1 Hz, a range of temperatures of −20 to 100° C., and a temperature-raising rate of 5° C./minute to calculate out the shear storage modulus at 23° C.

### <Separator Peel Strength Measurement>

About each of the examples, its separator-attached (i.e., its release-liner-attached) measuring samples (separator-attached pressure-sensitive adhesive layer A and separator-attached pressure-sensitive adhesive layer B) were each cut into a piece having a width of 50 mm and a length of 100 m to yield specimens. The peel strength (N/50-mm) of each of the specimens was measured when the separator (release-liner) was peeled off from the specimen, using a tension tester at a peeling angle of 180° and a peel rate of 300 mm/min.

### <Curl>

Any one of the double-sided pressure-sensitive-adhesive-layer-attached polarizing films of each of the examples was cut into a rectangular piece having a length of 300 mm in the absorption direction of the polarizing film, and having a length of 250 mm in a direction orthogonal to the absorption axis. The piece was put onto a horizontal plane such that a surface thereof curled into a convex form faces downward. The distance (mm) of a point farthest from the horizontal plane, out of the four corner points, from the plane was measured.

### <Yield Ratio>

The separator SB was peeled off from each of any ten films (that were made into a size of 70 mm and 100 mm) of the double-sided pressure-sensitive-adhesive-layer-attached polarizing films of each of the examples, and then the pressure-sensitive adhesive layer B side thereof was bonded to a non-alkali glass piece (1737, manufactured by Corning Inc.) having a thickness of 0.7 mm.

It was checked, about each of the 10 specimens, whether or not the bonding operation succeeded without causing a matter that edges of the bonded body bit an air bubble. The yield ratio in the example was evaluated in accordance with a criterion described below, using the proportion of specimens about which the edges bit no air bubble (success ratio), out of the 10 specimens.

⊙: the success ratio was 100%.

◯: the success ratio was 80% or more, and less than 100%.

Δ: the success ratio was 50% or more, and less than 80%.

x: the success ratio was less than 50%.

### <Method for Evaluating Step-Absorbing Capability>

From any one of the pressure-sensitive adhesive sheets of each of the examples, a sheet piece having a width of 50 mm and a length of 100 mm was cut out. From the sheet piece, one of its release films was peeled off. A hand roller was used to bond the pressure-sensitive adhesive layer side of the sheet piece onto a COP (cyclic polyolefin) film (thickness: 100 μm).

Next, from the sheet piece, onto which the COP film had been bonded, the other release film was peeled off.

A glass plate having a printed-step was bonded onto the COP film to bring the step arranged surface of this glass plate into contact with the pressure-sensitive adhesive layer A of the COP film under bonding conditions described below. In this way, an evaluating sample was yielded, which had a structure of “COP film/pressure-sensitive adhesive layer A/glass plate having a printed-step”.

Bonding conditions:

Surface pressure: 0.3 MPa

Bonding speed: 25 mm/s

Roll rubber hardness: 70°

The used glass plate having a printed-step was a glass plate (manufactured by Matsunami Glass Ind., Ltd.; length: 100 mm, width: 50 mm, and thickness: 0.7 mm) having one surface on which printing was made to have printed regions having a thickness (step height) of 50 μm or 80 μm.

The value (%) of {[“step height”/“thickness of the pressure-sensitive adhesive layer”]×100} thereof was 50% or 80%, this value being a factor representing step-absorbing capability.

Next, the evaluating sample was put into an autoclave, and then subjected to autoclave treatment at a pressure of 5 atom and a temperature of 50° C. for 15 minutes. After the autoclave treatment, the evaluating sample was taken out to observe a bonding state between the pressure-sensitive adhesive layer and the glass plate having a printed-step visually. The step-absorbing capability of the sample was evaluated in accordance with the following evaluating criterion: ◯: no air bubbles remained and no gap was generated between the pressure-sensitive adhesive layer and the step-printed glass plate.

x: air bubbles remained and one or more gaps were generated between the pressure-sensitive adhesive layer and the step-printed glass plate.

### <Durability>

The separator of the pressure-sensitive adhesive layer A (at the viewer-side) of each of any two of the pressure-sensitive-adhesive-layer-attached polarizing films yielded in each of the examples was peeled, and then bonded onto a cover glass having a thickness of 0.7 mm and made of non-alkali glass (1737, manufactured by Corning Inc.), using a laminator. Next, the resultants were each subjected to autoclave treatment at 50° C. and 0.5 MPa for 15 minutes to cause the pressure-sensitive-adhesive-layer-attached polarizing film to adhere closely onto the cover glass. Next, a vacuum bonding device manufactured by Lantech Inc. was used to vacuum-bond these members onto each other at a pressure of 0.2 MPa and a vacuum degree of 30 Pa. The resultant samples were put into a 85° C., 95° C. heating-oven (heated) and a 60° C./95%-RH thermostat (humidified), respectively. After 500 hours, the respective durabilities of the samples were evaluated by determining whether or not their polarizing film was peeled in accordance with the following criterion:

⊙: no peel was recognized.

◯: such a peel that was unable to be visually recognized was present.

Δ: such a slight peel that was able to be visually recognized was present.

x: a clear peel (more than 0.5 μm) was recognized.

TABLE 2

| | | | | | | | | Polarizing | | |
|---|---|---|---|---|---|---|---|---|---|---|
| | | | | | | | | film (at | | |
| | | | | | | | | pressure- | | |
| | Separator SA₁ | | Pressure-sensitive | | | Separator SA₂ | | sensitive | Separator SB | |
| | | Peel | adhesive layer A | | | | Peel | adhesive | | Peel |
| | | strength | | | Storage | | strength | layerAside) | | strength |
| | Thickness | a₁ | | Thickness | modulus | Thickness | a₂ | Corona | Thickness | b |
| | (μm) | (N/50 mm) | Type | (μm) | (MPa) | (μm) | (N/50 mm) | treatment | (μm) | (N/50 mm) |
| Example 1 | 50 | 0.3 | A1 | 50 | 0.07 | 50 | 0.15 | Conducted | 38 | 0.1 |
| Example 2 | 50 | 0.3 | A1 | 100 | 0.07 | 50 | 0.15 | Conducted | 38 | 0.1 |
| Example 3 | 50 | 0.3 | A1 | 200 | 0.07 | 50 | 0.15 | Conducted | 38 | 0.1 |
| Example 4 | 50 | 0.3 | A1 | 300 | 0.07 | 50 | 0.15 | Conducted | 38 | 0.1 |
| Example 5 | 38 | 0.3 | A1 | 100 | 0.07 | 50 | 0.15 | Conducted | 38 | 0.1 |
| Example 6 | 75 | 0.35 | A1 | 100 | 0.07 | 50 | 0.15 | Conducted | 38 | 0.1 |
| Example 7 | 50 | 0.35 | A1 | 100 | 0.07 | 50 | 0.15 | Conducted | 50 | 0.15 |
| Example 8 | 50 | 0.35 | A1 | 100 | 0.07 | 50 | 0.15 | Conducted | 75 | 0.2 |
| Example 9 | 50 | 0.3 | A2 | 100 | 0.03 | 50 | 0.15 | Conducted | 38 | 0.1 |
| Example 10 | 50 | 0.3 | A3 | 100 | 0.15 | 50 | 0.15 | Conducted | 38 | 0.1 |
| Example 11 | 50 | 0.3 | A1 | 100 | 0.07 | 50 | 0.15 | Conducted | 38 | 0.1 |
| Example 12 | 50 | 0.3 | A1 | 100 | 0.07 | 50 | 0.15 | Conducted | 38 | 0.1 |
| Example 13 | 50 | 0.3 | A1 | 100 | 0.07 | 50 | 0.15 | Not | 38 | 0.1 |
| | | | | | | | | conducted | | |
| Comparative | 50 | 0.3 | A1 | 100 | 0.07 | 50 | 0.15 | Conducted | 38 | 0.1 |
| Example 1 | | | | | | | | | | |
| Comparative | 50 | 0.3 | A1 | 100 | 0.07 | 50 | 0.15 | Conducted | 38 | 0.1 |
| Example 2 | | | | | | | | | | |
| Comparative | 50 | 0.3 | A1 | 100 | 0.07 | 50 | 0.15 | Conducted | 38 | 0.1 |
| Example 3 | | | | | | | | | | |
| Comparative | 50 | 0.3 | A4 | 100 | 0.01 | 50 | 0.15 | Conducted | 38 | 0.1 |
| Example 4 | | | | | | | | | | |
| Comparative | 50 | 0.3 | A5 | 100 | 0.5 | 50 | 0.15 | Conducted | 38 | 0.1 |
| Example 5 | | | | | | | | | | |

| | Method for bonding pressure-sensitive | | | | | | | | | |
|---|---|---|---|---|---|---|---|---|---|---|
| | adhesive layer A to single-sided | | | | | | | | | |
| | pressure-sensitive-adhesive-layer-B- | | | | | | | | | |
| | attached polarizing film | | | | | | | | | |
| | | | Single- | | | | | | | |
| | | Single- | sided | | | | | | | |
| | | sided | pressure- | | | | | | | |
| | | separator- | sensitive- | | | | | | | |
| | | attached | adhesive- | | | | | | | |
| | | pressure- | layer-B- | | | | | | | |
| | | sensitive | attached | | | | | | | |
| | | adhesive | polarizing | | | | | | | |
| | | layer A | film | Tensile | Evaluations | | | | | |
| | | Tensile | Tensile | strength | Curl | | Step- | | | |
| | | strength | strength | ratio | quantity | Yield | Absorbing | Durability | | |
| | Manner | T1 (N/m) | T2 (N/m) | (T1/T2) | (mm) | ratio | Capability | 85° C. | 95° C. | 60° C./95% RH |
| Example 1 | Roll-to-roll | 180 | 50 | 3.6 | 30 | ⊙ | ◯ | ⊙ | ◯ | ⊙ |
| Example 2 | Roll-to-roll | 180 | 50 | 3.6 | 15 | ⊙ | ◯ | ⊙ | ⊙ | ⊙ |
| Example 3 | Roll-to-roll | 180 | 50 | 3.6 | 6 | ⊙ | ◯ | ⊙ | ⊙ | ⊙ |
| Example 4 | Roll-to-roll | 180 | 50 | 3.6 | 4 | ⊙ | ◯ | ⊙ | ⊙ | ⊙ |
| Example 5 | Roll-to-roll | 180 | 50 | 3.6 | 3 | ⊙ | ◯ | ⊙ | ⊙ | ⊙ |
| Example 6 | Roll-to-roll | 180 | 50 | 3.6 | 25 | ⊙ | ◯ | ⊙ | ⊙ | ⊙ |
| Example 7 | Roll-to-roll | 180 | 50 | 3.6 | 35 | ◯ | ◯ | ⊙ | ⊙ | ⊙ |
| Example 8 | Roll-to-roll | 180 | 50 | 3.6 | 42 | ◯ | ◯ | ⊙ | ⊙ | ⊙ |
| Example 9 | Roll-to-roll | 180 | 50 | 3.6 | 2 | ⊙ | ◯ | ⊙ | ◯ | ⊙ |
| Example 10 | Roll-to-roll | 180 | 50 | 3.6 | 22 | ⊙ | ◯ | ⊙ | ⊙ | ◯ |
| Example 11 | Roll-to-roll | 180 | 180 | 1.0 | 0 | ⊙ | ◯ | ⊙ | ⊙ | ⊙ |
| Example 12 | Roll-to-roll | 270 | 50 | 5.4 | 55 | ◯ | ◯ | ⊙ | ⊙ | ⊙ |
| Example 13 | Roll-to-roll | 180 | 50 | 3.6 | 35 | ◯ | ◯ | ⊙ | ⊙ | ⊙ |
| Comparative | One-piece/ | 180 | 50 | 3.6 | −15 | X: air-bubble- | ◯ | ⊙ | ⊙ | ⊙ |
| Example 1 | one-piece | | | | | biting by edges | | | | |
| | bonding | | | | | | | | | |
| Comparative | One-piece/ | 180 | 50 | 3.6 | −15 | X: air-bubble- | ◯ | ⊙ | ⊙ | ⊙ |
| Example 2 | one-piece | | | | | biting by edges | | | | |
| | bonding | | | | | | | | | |
| Comparative | Roll-to-roll | 160 | 180 | 0.8 | −15 | X: air-bubble- | ◯ | ⊙ | ⊙ | ⊙ |
| Example 3 | | | | | | biting by edges | | | | |
| Comparative | Roll-to-roll | 180 | 50 | 3.6 | −2 | Δ | ◯ | ◯ | X | ⊙ |
| Example 4 | | | | | | | | | | |
| Comparative | Roll-to-roll | 180 | 50 | 3.6 | 4 | ⊙ | X: generation | ⊙ | ⊙ | X |
| Example 5 | | | | | | | of air bubbles | | | |

The result “generation of air bubbles” of Comparative Example 5 represents the following: after the bonding of the cover glass, the pressure-sensitive adhesive layer A was not completely embedded into the ink steps of the cover glass since the layer A was high in storage modulus; and air bubbles were generated just after the bonding.

TABLE 3

| | | | | Method for bonding separator SA₁′ for curl-adjustment to | | | |
|---|---|---|---|---|---|---|---|
| | | | | double-sided pressure-sensitive-adhesive-layer- | | | |
| | | | | attached polarizing film | | | |
| | | | | | | Double-sided | |
| | | | | | | pressure- | |
| | | | | | | sensitive- | |
| | Example or | | | | | adhesive- | |
| | Comparative | Separator SA₁′ for | | | Separator SA₁′ for | layer-attached | |
| | Example having | curl-adjustment | | | curl-adjustment | polarizing film | |
| | separator SA₁ | | Peel | | Tensile strength | Tensile strength | Tensile |
| | necessary to | Thickness | strength a₁′ | | T3 | T4 | strength ratio |
| | replace | (μm) | (N/50 mm) | Manner | (N/m) | (N/m) | (T3/T4) |
| Example 14 | Comparative | 50 | 0.2 | Roll-to-roll | 160 | 40 | 4.0 |
| | Example 3 | | | | | | |
| Comparative | Example 2 | 50 | 0.2 | Roll-to-roll | 160 | 180 | 0.8 |
| Example 6 | | | | | | | |

| | Evaluations | | | | | |
|---|---|---|---|---|---|---|
| | Curl | | Step- | | | |
| | quantity | | Absorbing | Durability | | |
| | (mm) | Yield ratio | Capability | 85° C. | 95° C. | 60° C./95% RH |
| Example 14 | 20 | ⊙ | ◯ | ⊙ | ⊙ | ⊙ |
| Comparative | −20 | X: air-bubble- | ◯ | ⊙ | ⊙ | ⊙ |
| Example 6 | | biting by edges | | | | |

In Comparative Example 6, the properties were deteriorated by replacing the separator SA₁′.

### DESCRIPTION OF REFERENCE SIGNS

1 a polarizing film
A pressure-sensitive adhesive layer A (viewer side)
B pressure-sensitive adhesive layer B (opposite to the viewer side)
C member (touch panel or transparent substrate)
D display section (image display device)
SA₁ separator of the pressure-sensitive adhesive layer A (viewer side)
SA₁′ separator of the pressure-sensitive adhesive layer A (viewer side) for curl-adjustment
SA₂ separator of the pressure-sensitive adhesive layer A (viewer side)
SB separator of pressure-sensitive adhesive layer B (opposite to the viewer side)
10, 10′ double-sided pressure-sensitive-adhesive-layer-attached polarizing film
11 single-sided separator-attached pressure-sensitive adhesive layer A
12 single-sided pressure-sensitive-adhesive-layer-B-attached polarizing film
13 separator-SA₁-peeled double-sided pressure-sensitive-adhesive-layer-attached polarizing film
14 double-sided separator-attached pressure-sensitive adhesive layer A
2 pressure-sensitive adhesive layer (pressure-sensitive adhesive layer B)
3 transparent conductive layer (antistatic layer)
4 glass substrate
5 liquid crystal layer
6 driving electrode
7 antistatic layer functioning also as a sensor layer
8 driving electrode functioning also as a sensor layer
9 sensor layer
a first pressure-sensitive adhesive layer
b second pressure-sensitive adhesive layer

What is claimed is:

1. A double-sided pressure-sensitive-adhesive-layer-attached polarizing film, comprising:
a polarizing film which is provided nearest to a viewer-side of an image display device among at least one polarizing film used in the device;
a pressure-sensitive adhesive layer A arranged at the viewer-side of the polarizing film;
a pressure-sensitive adhesive layer B arranged at aside of the polarizing film that is opposite to the pressure-sensitive adhesive layer A;
a separator SA₁ provided on the pressure-sensitive adhesive layer A; and
a separator SB provided on the pressure-sensitive adhesive layer B; and
wherein the pressure-sensitive adhesive layer A has a storage modulus of 0.02 to 0.3 MPa at 23° C., and
about a rectangular piece cut out from the double-sided pressure-sensitive-adhesive-layer-attached polarizing film, the piece having a length of 300 mm in the direction of an absorption axis of the polarizing film, and a length of 250 mm in a direction orthogonal to the absorption axis, in an analysis of putting the piece on a horizontal plane such that a surface of the piece that is curled into a convex form faces downward, and then measuring the quantity of the curl (provided that the curl quantity measured in the state that the double-sided pressure-sensitive-adhesive-layer-attached polarizing film is put onto the horizontal plane such that the separator SB side of the film faces downward is represented by a numerical value with “+”, and the curl quantity measured in the state that the double-sided pressure-sensitive-adhesive-layer-attached polarizing film is put onto the horizontal plane such that the separator SA₁ side of the film faces downward is represented by a numerical value with “−”), the curl quantity is from −10 to +60 mm.

2. The double-sided pressure-sensitive-adhesive-layer-attached polarizing film according to claim 1, wherein the curl quantity is from +2 to +30 mm.

3. The double-sided pressure-sensitive-adhesive-layer-attached polarizing film according to claim 1, wherein the separator SA₁ has a thickness of 50 μm or more, and the separator SB has a thickness of 30 to 55 μm.

4. The double-sided pressure-sensitive-adhesive-layer-attached polarizing film according to claim 1, wherein a peel strength a₁ of the separator SA₁ is higher than a peel strength b of the separator SB.

5. A method for producing a double-sided pressure-sensitive-adhesive-layer-attached polarizing film according to claim 1,
comprising a step (1) of:
preparing a single-sided pressure-sensitive-adhesive-layer-B-attached polarizing film having a polarizing film which is provided nearest to a viewer-side of an image display device among at least one polarizing film used in the device, a pressure-sensitive adhesive layer B, and a separator SB provided onto the pressure-sensitive adhesive layer B;
preparing a single-sided separator-attached pressure-sensitive adhesive layer A having a separator SA₁, and a pressure-sensitive adhesive layer A arranged over the separator SA₁ and having a storage modulus of 0.02 to 0.3 MPa at 23° C.; and
bonding the single-sided pressure-sensitive-adhesive-layer-B-attached polarizing film and the single-sided separator-attached pressure-sensitive adhesive layer A to each other, in a roll-to-roll manner, to arrange the pressure-sensitive adhesive layer A of the single-sided separator-attached pressure-sensitive adhesive layer A over a side of the polarizing film of the single-sided pressure-sensitive-adhesive-layer-B-attached polarizing film, the side being an side of the polarizing film that is opposite to the pressure-sensitive adhesive layer B arranged side of the polarizing film.

6. The method for producing the double-sided pressure-sensitive-adhesive-layer-attached polarizing film according to claim 5, wherein the single-sided separator-attached pressure-sensitive adhesive layer A is a layer obtained through a step (a) of peeling off, from a double-sided separator-attached pressure-sensitive adhesive layer A having the separator SA₁ at one side of the pressure-sensitive adhesive layer A and having a separator SA₂ at the other side of the pressure-sensitive adhesive layer A, the separator SA₂; and
a peel strength a₁ of the separator SA₁, a peel strength a₂ of the separator SA₂, and a peel strength b of the separator SB satisfy a relationship of a₁>a₂≧b.

7. The method for producing the double-sided pressure-sensitive-adhesive-layer-attached polarizing film according to claim 6, wherein the peel strength a₁ of the separator SA₁, the peel strength a₂ of the separator SA₂, and the peel strength b of the separator SB satisfy a relationship of a₁>1.5a₂≧1.5b.

8. The method for producing the double-sided pressure-sensitive-adhesive-layer-attached polarizing film according to claim 5, wherein in the roll-to-roll manner bonding step (1),
the ratio of the tensile strength T1 of the single-sided separator-attached pressure-sensitive adhesive layer A to the tensile strength T2 of the single-sided pressure-sensitive-adhesive-layer-B-attached polarizing film (T1/T2) is controlled into 0.8 or more.

9. The method for producing the double-sided pressure-sensitive-adhesive-layer-attached polarizing film according to according to claim 5, comprising, after the step (1),
a step (b) of peeling off the separator SA₁ from the resultant double-sided pressure-sensitive-adhesive-layer-attached polarizing film, and
a step (2) of bonding a separator SA₁′ for curl-adjustment in a roll-to-roll manner to the pressure-sensitive adhesive layer A of the double-sided pressure-sensitive-adhesive-layer-attached polarizing film, from which the separator SA₁ has been peeled off.

10. The method for producing the double-sided pressure-sensitive-adhesive-layer-attached polarizing film according to claim 9, wherein in the roll-to-roll-manner bonding step (2),
the ratio of the tensile strength T3 of the separator SA₁′ for curl-adjustment to the tensile strength T4 of the double-sided pressure-sensitive-adhesive-layer-attached polarizing film, from which the separator SA₁ has been peeled off, (T3/T4) is controlled to 0.8 or more.

11. The method for producing the double-sided pressure-sensitive-adhesive-layer-attached polarizing film according to claim 5, comprising, after the step (1),
a step (c) of cutting the resultant double-sided pressure-sensitive-adhesive-layer-attached polarizing film into any size, and
a step (d) of cutting an edge of the double-sided pressure-sensitive-adhesive-layer-attached polarizing film obtained by the cutting.

12. An image display device, having at least one or more double-sided pressure-sensitive-adhesive-layer-attached polarizing films,
wherein the double-sided pressure-sensitive-adhesive-layer-attached polarizing film which is provided nearest to a viewer-side of an image display device among at least one polarizing film used in the device, is a double-sided pressure-sensitive-adhesive-layer-attached polarizing film obtained by removing the separators SA₁ and SB from the double-sided pressure-sensitive-adhesive-layer-attached polarizing film recited in claim 1, and
the pressure-sensitive adhesive layer A of the double-sided pressure-sensitive-adhesive-layer-attached polarizing film is arranged at the viewer-side of the image display device, and the pressure-sensitive adhesive layer B of the double-sided pressure-sensitive-adhesive-layer-attached polarizing film is arranged at a display section side of the device.

13. The double-sided pressure-sensitive-adhesive-layer-attached polarizing film according to claim 2, wherein the separator SA₁ has a thickness of 50 μm or more, and the separator SB has a thickness of 30 to 55 μm.

14. The double-sided pressure-sensitive-adhesive-layer-attached polarizing film according to claim 2, wherein a peel strength a₁ of the separator SA₁ is higher than a peel strength b of the separator SB.

15. The double-sided pressure-sensitive-adhesive-layer-attached polarizing film according to claim 3, wherein a peel strength a₁ of the separator SA₁ is higher than a peel strength b of the separator SB.

16. A method for producing a double-sided pressure-sensitive-adhesive-layer-attached polarizing film according to claim 2,
comprising a step (1) of:
preparing a single-sided pressure-sensitive-adhesive-layer-B-attached polarizing film having a polarizing film which is provided nearest to a viewer-side of an image display device among at least one polarizing film used in the device, a pressure-sensitive adhesive layer B, and a separator SB provided onto the pressure-sensitive adhesive layer B;
preparing a single-sided separator-attached pressure-sensitive adhesive layer A having a separator SA₁, and a pressure-sensitive adhesive layer A arranged over the separator SA₁ and having a storage modulus of 0.02 to 0.3 MPa at 23° C.; and
bonding the single-sided pressure-sensitive-adhesive-layer-B-attached polarizing film and the single-sided separator-attached pressure-sensitive adhesive layer A to each other, in a roll-to-roll manner, to arrange the pressure-sensitive adhesive layer A of the single-sided separator-attached pressure-sensitive adhesive layer A over a side of the polarizing film of the single-sided pressure-sensitive-adhesive-layer-B-attached polarizing film, the side being an side of the polarizing film that is opposite to the pressure-sensitive adhesive layer B arranged side of the polarizing film.

17. A method for producing a double-sided pressure-sensitive-adhesive-layer-attached polarizing film according to claim 3,
comprising a step (1) of:
preparing a single-sided pressure-sensitive-adhesive-layer-B-attached polarizing film having a polarizing film which is provided nearest to a viewer-side of an image display device among at least one polarizing film used in the device, a pressure-sensitive adhesive layer B, and a separator SB provided onto the pressure-sensitive adhesive layer B;
preparing a single-sided separator-attached pressure-sensitive adhesive layer A having a separator SA₁, and a pressure-sensitive adhesive layer A arranged over the separator SA₁ and having a storage modulus of 0.02 to 0.3 MPa at 23° C.; and
bonding the single-sided pressure-sensitive-adhesive-layer-B-attached polarizing film and the single-sided separator-attached pressure-sensitive adhesive layer A to each other, in a roll-to-roll manner, to arrange the pressure-sensitive adhesive layer A of the single-sided separator-attached pressure-sensitive adhesive layer A over a side of the polarizing film of the single-sided pressure-sensitive-adhesive-layer-B-attached polarizing film, the side being an side of the polarizing film that is opposite to the pressure-sensitive adhesive layer B arranged side of the polarizing film.

18. A method for producing a double-sided pressure-sensitive-adhesive-layer-attached polarizing film according to claim 4,
comprising a step (1) of:
preparing a single-sided pressure-sensitive-adhesive-layer-B-attached polarizing film having a polarizing film which is provided nearest to a viewer-side of an image display device among at least one polarizing film used in the device, a pressure-sensitive adhesive layer B, and a separator SB provided onto the pressure-sensitive adhesive layer B;
preparing a single-sided separator-attached pressure-sensitive adhesive layer A having a separator SA₁, and a pressure-sensitive adhesive layer A arranged over the separator SA₁ and having a storage modulus of 0.02 to 0.3 MPa at 23° C.; and
bonding the single-sided pressure-sensitive-adhesive-layer-B-attached polarizing film and the single-sided separator-attached pressure-sensitive adhesive layer A to each other, in a roll-to-roll manner, to arrange the pressure-sensitive adhesive layer A of the single-sided separator-attached pressure-sensitive adhesive layer A over a side of the polarizing film of the single-sided pressure-sensitive-adhesive-layer-B-attached polarizing film, the side being an side of the polarizing film that is opposite to the pressure-sensitive adhesive layer B arranged side of the polarizing film.

19. The method for producing the double-sided pressure-sensitive-adhesive-layer-attached polarizing film according to claim 6, wherein in the roll-to-roll manner bonding step (1),
the ratio of the tensile strength T1 of the single-sided separator-attached pressure-sensitive adhesive layer A to the tensile strength T2 of the single-sided pressure-sensitive-adhesive-layer-B-attached polarizing film (T1/T2) is controlled into 0.8 or more.

20. The method for producing the double-sided pressure-sensitive-adhesive-layer-attached polarizing film according to claim 7, wherein in the roll-to-roll manner bonding step (1),
the ratio of the tensile strength T1 of the single-sided separator-attached pressure-sensitive adhesive layer A to the tensile strength T2 of the single-sided pressure-sensitive-adhesive-layer-B-attached polarizing film (T1/T2) is controlled into 0.8 or more.
